(19) United States
(12) Patent Application Publication
(10) Pub. No.: US 2025/0022627 A1
(43) Pub. Date: Jan. 16, 2025

(54) Nuclear Waste Management

(71) Applicant: Henry CRICHLOW, Norman, OK (US)

(72) Inventor: Henry CRICHLOW, Norman, OK (US)

(21) Appl. No.: 18/753,639

(22) Filed: Jun. 25, 2024

Related U.S. Application Data
(63) Continuation-in-part of application No. 18/108,001, filed on Feb. 9, 2023.
(63) Continuation-in-part of application No. 18/235,277, filed on Aug. 17, 2023.

(51) Int. Cl. G21F 9/30; B22D 17/08; B22D 17/20; B22D 19/00; G21F 5/008; G21F 9/34; E21B 41/00

(52) U.S. Cl. CPC G21F 9/302; B22D 17/08; B22D 17/2084; B22D 19/00; G21F 5/008; G21F 9/34; E21B 41/005

(57) ABSTRACT

Nuclear waste, such as, but not limited to, spent nuclear fuel (SNF) assemblies or portions thereof, are placed within diecast molds, and then gravity fed molding occurs within those loaded diecast molds and around the SNF assemblies (or portions thereof) that are located within those diecast molds, using molten alloy(s) for filling the diecast molds, to form solid metal ingots (castings) upon sufficient cooling of the newly formed ingots. The molten alloy(s) may contain a copper alloy. The molten alloy(s) may also contain neutron absorbers. Each such formed ingot may entirely encapsulate a SNF assembly (or a portion thereof) within the resolidified alloy(s). The ingots may be placed into waste capsules. The ingots and/or the waste capsules may be landed in deeply located horizontal wellbores. The deeply located horizontal wellbores may be at least partially located within deeply located geologic formations.

### PRIORITY NOTICE

The present patent application, as a continuation-in-part (CIP) patent application, claims priority under 35 U.S.C. § 120 to earlier filed and copending U.S. nonprovisional patent application Ser. No. 18/235,277 filed on Aug. 17, 2023, by the same inventor as the present patent application; wherein the disclosure of U.S. nonprovisional patent application Ser. No. 18/235,277 is incorporated herein by reference in its entirety.

The present patent application, as a continuation-in-part (CIP) patent application, claims priority under 35 U.S.C. § 120 to earlier filed and copending U.S. nonprovisional patent application Ser. No. 18/108,001 filed on Feb. 9, 2023, by the same inventor as the present patent application; wherein the disclosure of U.S. nonprovisional patent application Ser. No. 18/108,001 is incorporated herein by reference in its entirety.

### CROSS REFERENCE TO RELATED U.S. PATENTS

The disclosures and teachings of U.S. utility U.S. Pat. Nos. 5,850,614, 6,238,138, 10427191, 10518302, 10807132, and 11289234, all by the same inventor as the present patent application, are all incorporated by reference as if fully set forth herein.

### TECHNICAL FIELD OF THE INVENTION

The present invention relates in general to containment, preparation, storage, and/or disposal of radioactive materials, such as, but not limited to, nuclear waste; and, more specifically, to the containment, preparation, storage, and/or disposal of modified spent nuclear fuel (SNF) assemblies, portions thereof, and/or other radioactive waste forms, into generally cylindrical solid metal disposal castings and/or capsules, wherein such generally cylindrical solid metal disposal castings and/or capsules may then be emplaced within deeply located geological formations of predetermined characteristics (such as, but not limited to predetermined rock properties) in which geological repositories may be implemented as human-made deep horizontal (lateral) wellbores in the deeply located geological formations.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Today (circa 2024), there is a massive quantity of nuclear waste accumulating across the world, including across the United States (U.S.). There are two significant sources of a majority of nuclear waste. The first source is high-level waste (HLW) from generating electric power in nuclear-fired power plants and a second is from military nuclear operations. All sources of radioactive (nuclear) waste must be addressed, controlled, and disposed of safely. This patent application addresses at least one of these sources of waste and how to dispose of that nuclear (radioactive) waste safely which includes disposing in a timely manner. This patent application is directed to the disposal of at least spent nuclear fuel (SNF) materials such that the SNF may be disposed of safely, securely, economically, and timely. SNF may be a subcategory of HLW.

The novel approach illustrated in this patent application involves the integration of two distinctly different technologies. First, high-level nuclear waste (HLW) management of SNF assemblies; and second, gravity die-casting technology and operations. These two approaches are combined to provide novel means and methods of forming and protecting HLW (SNF) capsules for ultimate disposal in deep geological repositories.

Gravity die casting may entail pouring under gravity molten metal(s) (and/or alloy(s)) into a specially shaped three-dimensional (3D) mold, cast, and/or die. The selected poured/injected metal may be heated separately until it melts.

The viscosity of molten copper decreases (becomes more liquid like) with increasing temperature, reflecting its fluidity at higher temperatures. At its melting point of 1,083 degrees Celsius (° C.), copper has a viscosity of approximately 4.4 centipoises (cP). As the temperature rises to 1,200° C., the viscosity drops to about 3.7 cP, and further decreases to around 2.9 cP at 1,400° C. This reduction in viscosity with temperature is typical for molten metals, facilitating processes such as casting and alloying by enhancing the flow characteristics of the liquid metal.

The molten liquid may then be rapidly poured into a mold, cast, and/or die cavity; and, then the melted metal takes the mold's shape once it has sufficiently cooled down to resolidify.

A gravity die-casting process may comprise at least some steps, such as, but not limited to, mold (die) preparation, pouring the melt and, finally, cleanup of the cast item. The gravity die casting process may allow for high automation, mass-production, relatively low-costs, high-quality resolidified metallic components with high precision and high repeatability. These features may provide benefits in the disposal of HLW (SNF) products (materials).

Embodiments of the present invention may be based, at least in part, on the realization that considerable advantages can be gained if a copper (or similar alloy) is used for embedding and enclosing the spent nuclear fuel (SNF) rods to form a composite mass ingot in which the SNF and the alloy form a solid matrix.

One advantage is that resistance to chemical corrosion is vastly increased by the fact that the coherent mass of copper (or the like alloy) infused ingot, formed from the copper (or the like alloy) infused SNF combination, is more resistant to corrosion than a hollow copper container in which the SNF assembles are placed and enclosed. This is due, on the one hand, to copper (or the like alloy) in itself being more resistant to corrosion and, on the other hand, to the protection afforded by having a coherent mass of a single material.

Another advantage is that the interior of this solid matrix of copper and SNF can be made substantially (mostly) free from cavities (voids), which is hardly possibly if merely using a hollow container in which SNF assemblies are placed within, and subsequently welding a lid onto that container.

A further advantage is that the solid composite matrix of copper and SNF effectively becomes a dense monolithic system, a single entity without any joint, or any transition area of a different material composition existing between them. Therefore, there are no weak points in the composite matrix system. In this application, the intra-SNF embedding of the copper alloy is done with a gravity-fed injection process rather than a very complex, costly, high temperature, high pressure, long duration hot isostatic pressing (HIP) process.

This gravity-fed process as taught herein, has hitherto fore not been disclosed for the encapsulation of SNF assembly devices under these conditions.

To date, no efforts have been made to modify or transform the physical SNF assembly before disposal in the manners taught herein. Current processes use the physical SNF assembly, unchanged, in the same form as it exits its cooling pond. Most efforts have been made to cloak, cover, enclose, or protect the SNF externally. Whereas, the technology provided herein in this current patent application is a substantial departure from the current and prior art and is directed towards an effective means of protection, minimizing corrosion, and minimizing radionuclide migration when the SNF assembly (or other HLW) is disposed of (in a deep geological repository) as taught herein.

Current and prior art disposal of SNF as HLW in vertical wellbores involves the placement of the nuclear waste (e.g., SNF) within capsules (containers), wherein the capsules containing the nuclear waste (SNF) are then usually placed in a bottom one-third section of a vertical wellbore. Published data show that compressive and tensile stresses acting on these vertically-disposed capsules can exceed 5,000 psi (pounds per square inch) or more depending on the depth and quantity of capsules strung together, which could contribute to failure and/or breach of such prior art capsule systems and in turn could result in unintended radionuclide migration.

Then, in the current and prior art SNF disposal systems, wellbore sealing plugs have been placed above the emplaced capsules. Above these sealing plugs are various backfill materials that are designed to swell and fill remaining portions of the vertical wellbore. However, in practice, some structural/physical changes may occur in and at the near wellbore region between the drilled-out wellbore and the native rock formation due to the drilling process. Fissures, microfractures, and permeability changes may occur at the interface between the wellbore and into the proximate (adjacent) surrounding native rock, sometimes called “near-wellbore damage” in the oil drilling industry. Furthermore, based on observations of the erosion of bentonite mud accretions that accumulate on the surfaces of drilling mud pits in the open, possible erosion of the bentonite backfill due to fluid migration may occur. Published bentonite backfill testing analyses have overlooked this potential for physical erosion due to migrating fluids underground. These changes contribute to and may allow fluid bypass, migration, and movement of waste material, such as, but not limited to, radionuclides, over time out of the emplaced capsules and into the surrounding native rock-which is not a desired outcome.

Nuclear waste disposal in horizontal wellbores has been illustrated in some previous U.S. utility patents such as, 5850614, 6238138, 10427191, 10518302, 10807132, and 11289234, all by the same inventor as the present (current) patent application. The disclosures and teachings of U.S. utility patents 5850614, 6238138, 10427191, 10518302, 10807132, and 11289234, are all incorporated by reference as if fully set forth herein. This patent application may place encapsulated nuclear (radioactive) waste materials (in ingot form that may then be put into a capsule form) into lateral or horizontal wellbores drilled into deep geological formations.

Current and prior art spent nuclear fuel (SNF) assemblies are generally shown in FIG. 1A, in FIG. 1B, and in FIG. 1C. FIG. 1A is prior art and shows a Canadian model CANDU for a nuclear fuel assembly 101. FIG. 1B is prior art and shows a Russian nuclear fuel assembly 103. FIG. 1C is prior art and shows a group or bundle of U.S. nuclear fuel assemblies 105, with a plurality of single SNF assembly 106 being part of that bundle 105.

In prior art technology and operations, prior approaches to treating SNF assemblies are taught, at least some of which are depicted in FIG. 2A, in FIG. 2B, in FIG. 2C, and in FIG. 2D.

FIG. 2A is prior art and shows a SKB spent fuel (SNF) canister 201 and cradle 203 assembly used in Finland and in Sweden. The prior art SNF waste disposal approach taught in Finland (and Sweden) utilizes a set of SNF assemblies 205 that are emplaced in a structural cast iron honeycomb cradle 203 (scaffold 203) supporting structure. The cradle 203 with its held set of SNF assemblies 205 are capped with a cover (lid) 207. Then this composite structure (e.g., the cradle 203 with its held set of SNF assemblies 205 and the cover 207) are enclosed in a very thick-walled and corrosion-resistant heavy copper cylindrical canister 201. Canister 201 is then closed with a final cover (lid) 209. Then the massive copper cylindrical canister 201 along with its contents (of the cradle 203 that is holding the SNF assemblies 205), is then disposed of in vertical shafts implemented by drilling a “shallow” borehole in a floor of a tunnel or mine repository. Note, this type of prior art disposal system may have a serious problem and/or defect in that this type of prior art disposal system may be affected by the migration of surface waters, resulting in radioactive contaminated surface waters, as has been demonstrated by the detection of surface-generated chlorine-36 at sub-surface locations indicating the surface waters have reached the disposal depth. Eventually, over thousands of years the iron and copper protection may deteriorate and allow radionuclide migration away from the location. See e.g., FIG. 2A.

FIG. 2B is prior art and shows a Canadian spent fuel (SNF) canister 211 assembly for disposal in near-surface repositories. This prior art approach for SNF disposal, published in Canada, bundles the individual SNF assemblies 101 into a generally cylindrical bundle of SNF assemblies 101, wherein that bundle then gets emplaced inside a structural metal cylindrical canister 213 and then this structural metal cylindrical canister 213 (with the bundle of SNF assemblies 101) gets enclosed completely inside a large protective (massive) copper canister 211 with end caps (plugs) 215 which are friction welded to the original copper cylinder canister 211 member. This Canadian prior art solution has similar problems as indicated above in the discussion of FIG. 2A, namely, over extended time periods, having copper degradation from migrating (surface) waters and radionuclide migration. See e.g., FIG. 2B.

FIG. 2C is prior art and shows U.S. (proposed/planned) operations where spent fuel (SNF) assemblies 106 disposal is made in shallow mines or tunnel systems for in near-surface repositories like Yucca Mt in Nevada. This prior art approach, published in the U.S., emplaces groups of SNF assemblies 106 as integral waste packages on a rail-type system inside a near-surface (e.g., 300 meters [m] below terrestrial surface) tunnel 221 that is unrealistically and dangerously placed above the local water table. The tunnel 221 is surrounded along its length by a tunnel wall 223. The nuclear waste capsule packages are then expected to be protected by a set of titanium drip shields 225 which are supposed to be installed sometime in the future, after complete waste emplacement. It is hoped that these titanium “umbrellas” 225 can unrealistically protect the emplaced waste 106 from vertically migrating groundwater for 10,000 years. See e.g., FIG. 2C.

Today (2024) and in the recent past, the treatment and processing of SNF assemblies have been reported by at least three major groups or organizations, as indicated earlier (i.e., the Finnish, Canadian, and U.S. prior art methods for dealing with SNF discussed above). See e.g., FIG. 2A to FIG. 2C.

FIG. 2D of this present patent application is a prior art representation (reproduction) of a FIG. 1 from U.S. utility patent 4209420; further, the reference numerals shown in FIG. 2d are those from U.S. utility patent 4209420. FIG. 2D of this present patent application shows a prior art operation where spent fuel (SNF) assemblies are embedded in a solid composite matrix by a process called “hot isostatic pressing” (HIP). The process involves placing the waste material, mixed with glass or ceramic, into a sealed container. This container is then subjected over a prolonged period of time to high temperatures and high pressures in a specialized HIP furnace. This system essentially behaves like a high temperature closed high pressure cooker in common use. The hot isostatic pressing (HIP) process for nuclear waste encapsulation typically requires several hours or more to complete. The exact duration can vary depending on the specific materials and waste form being processed, but it generally ranges from two (2) to twenty-four (24) hours per cycle. This time frame includes the heating period to reach the desired temperature, the holding period at high temperature and pressure to ensure complete densification, and the cooling period. The precise parameters must be carefully controlled. The combination of heat and isostatic pressure causes the material to densify, eliminating voids and creating a solid, monolithic structure. This dense form minimizes the potential for radioactive leakage and enhances the long-term stability and safety of the waste form, making it suitable for secure, deep geological disposal.

Despite some possible or theoretical benefits, the HIP process faces several operational and other challenges that hinder its successful implementation. At least some of the key problems are: an excessively complex process; high financial costs to implement; difficult to scale-up; waste material compatibility issues; problems with monitoring and controlling the HIP process; regulatory and/or licensing issues; problems with public acceptance; problems with waste form stability and/or performance; a portion thereof; combinations thereof; and/or the like. With respect to the HIP process being excessively complex and having too high of financial costs, the HIP process requires unique and specialized equipment capable of withstanding the required extremely high pressures and high temperatures. Such equipment is financially expensive to purchase, commission, operate, and maintain. Further the complexity of the HIP process increases such financial costs, making it less economically viable compared to other waste management methods. Scaling up the HIP process from laboratory or pilot-scale to full industrial scale is beyond challenging. Ensuring uniform extremely high pressure and temperature distribution in large volumes of waste material is difficult, which can lead to inconsistencies in the final product. Handling and processing large quantities of radioactive waste in a HIP system is technically demanding and requires robust safety measures. Further, not all waste materials are suitable for HIP processing. Some waste materials may react adversely under the very high pressure and temperature conditions, leading to undesirable chemical reactions and/or phase changes. The development of suitable encapsulation materials that can effectively immobilize a wide range of radionuclides is still an ongoing challenge. Monitoring and controlling the HIP process is difficult due to its harsh operational environment. Ensuring that the process parameters are consistently maintained within the required very high pressure and temperature ranges is critical to producing a high-quality end product. Real-time monitoring of the encapsulated waste material during the HIP process is challenging, leading to potential uncertainties in the final end product quality. The U.S. legal regulatory framework for the disposal of nuclear waste is stringent, and untested technologies like HIP must undergo rigorous testing and validation to meet such regulatory requirements. Gaining regulatory approval for the HIP process, if possible, will be very time-consuming and very financially expensive, further delaying its implementation. The time and effort required to gain regulatory approval for the HIP process have greatly slowed its implementation. Public perception and acceptance of untested nuclear waste disposal technologies can be a significant barrier to adoption. Concerns about the safety and long-term reliability of the HIP process may lead to resistance from the public and stakeholders alike. Communicating any benefits of the HIP process to the public effectively would be crucial but challenging. Ensuring the long-term stability and performance of the end product waste forms produced by the HIP process is critical. This includes resistance to radiation damage, thermal cycling, and potential leaching of radionuclides. Comprehensive testing and modeling are required to demonstrate the durability of HIP-processed waste forms over geological timescales, which is a complex and resource-intensive task. Currently, there is uncertainty as to if the HIP process end product waste forms can meet such long-term requirements. The high financial and time costs associated with the HIP process, including scaling it up, its equipment, its operation, and its mandatory regulatory compliance, makes it less competitive compared to other waste management methods. Such issues have limited widespread adoption of the HIP process as applied to SNF. Other waste management and disposal methods, such as, vitrification and dry cask storage, have been more readily adopted due to at least some reliability and to lower costs as compared to the HIP process. In summary, while the HIP process might offer potential advantages for the encapsulation and disposal of spent nuclear fuel assemblies, it faces significant operational, technical, economic, and regulatory challenges. These challenges have prevented its successful and widespread implementation to date.

At least some embodiments of the present invention do not utilize a hot isostatic pressing (HIP) process.

These current FIG. 2A to FIG. 2C prior art approaches for SNF disposal tend to provide protection at what may be considered a “macro-level.” At the “macro level,” the basis for corrosion protection and/or mitigation of degradation of the SNF material is done wholly on the exterior surfaces of the containers (capsules) that house the SNF materials. In macro-level operations, no attempt is made for materials to protectively enter the innermost interstices of the SNF assembly matrix that make up the complex inner structure of a typical SNF assembly. In reality, there is considerable free space, porosity, or voids 301 between and around the collective internal structural elements (such as, fuel rods 303, control rods 305) that make up an SNF assembly, see e.g., FIG. 3A and FIG. 3B. FIG. 3A and FIG. 3B are prior art and show a single SNF assembly 106. These internal intricate void spaces 301, of a typical SNF assembly, may be easily computed empirically by a liquid displacement process on a given finished SNF assembly (or an equivalent method). In prior art disposal systems, the outer corrosion protective material is placed as a solid, a sheet, laminated, or other means outside of and covering over exteriors of the SNF assembly—but protective materials never enter the inner void spaces 301 of the SNF assembly (such as, but not limited to, SNF assembly 106).

Whereas and in complete contrast, the current novel patent application teaches methods, processes, steps, devices, apparatus, devices, and/or the like, in which protective material(s), such as, but not limited to, copper and/or copper alloy(s), may be meltingly added, under gravity, in liquid (molten) form, into a mold (cast and/or die) in which at least one complete (or partial) SNF assembly resides, such that this molten, liquid, and protective material(s) may enter and fill the void spaces 301 within the SNF assembly, and may do so using only gravity with no high pressure forcing injection.

In addition, in some embodiments, a selected (predetermined) neutron absorbent material may be added to the molten (liquid) metal (protective material) and this combined fluid may be inserted/poured, under gravity, into the die (cavity) holding the SNF assembly (or portion thereof) residing within the mold (cast and/or die). In some embodiments, the neutron absorbent materials may comprise boron carbide (B₄C).

Boron carbide (B₄C) contains a high concentration of boron, which has a strong affinity for absorbing thermal neutrons. When boron absorbs neutrons, it undergoes a nuclear reaction that produces alpha particles and lithium-7. This reaction helps reduce the neutron population and control the overall reactivity of the nuclear system. In Russia (2023) and in other countries, boron materials, like boron carbide (B₄C), and boron powder have been infused in plastics and successfully utilized in making neutron-absorbing composites for industrial uses.

Neutron absorbent materials like boron carbide B₄C are available in extremely fine powder form and may be mixed with the molten (liquid) metal (copper). This neutron absorbent has an extremely high melting point of 4,262 degrees Fahrenheit (° F.), which is much higher than the melting point of copper (which may be 1,984 degrees Fahrenheit [° F.] and/or around 2,000° F. depending upon the given copper alloy and operating pressure, plus or minus 100° F.).

Gravity die casting and high-pressure die casting are two prevalent manufacturing methods that involve pouring or injecting molten metal into molds to form parts, respectively. In gravity die casting, the molten metal fills the mold under the influence of gravity, typically using molds made of steel or cast iron. This method produces parts with a good surface finish and solid mechanical properties, suitable for medium-complexity components and medium to low production volumes. The process benefits from lower tooling costs and lower porosity levels due to a slower filling process, though it has longer cycle times because of the natural cooling and re-solidification of the metal.

The typical cycle time for a gravity die casting process can vary depending on the complexity and size of the part being cast, the type of alloy used, and the efficiency of the casting setup. For smaller and less complex parts, the cycle time can be closer to one (1) to two (2) minutes, while larger or more complex parts may require three (3) to five (5) minutes or more. On average, the cycle time for gravity die casting ranges from one (1) to five (5) minutes per casting, but shorter or longer cycle times may be possible. In some embodiments, the gravity die casting cycle time of metal output components may comprise the following steps: (a) mold preparation (cleaning and coating of the mold with a release agent, if necessary); (b) pouring (molten metal is poured into the mold cavity); (c) re-solidification (allowing the metal to cool and re-solidify within the mold); (d) mold opening and casting removal (opening the mold and removing the re-solidified casting); and (e) cooling and trimming (allowing the casting to cool further and trimming off any excess material or sprues).

Note, longer cycle times (e.g., five [5] minutes or more) are generally not a problem with respect to forming composite matrixes of copper and SNF assemblies as taught herein as gravity die casting may be scaled up to meet disposal needs of existing and new SNF.

In contrast, high-pressure die casting involves injecting molten metal into precision molds at high pressures, necessitating the use of durable hardened steel molds that can withstand the high pressures (and the high temperatures), as well as the equipment and machinery for generating, controlling, monitoring, and managing those high pressures. This high-pressure process requires more complex machinery and control processes. This high-pressure technique yields parts (castings) with excellent surface finishes and intricate details, making it ideal for complex parts and high-volume production. High-pressure die casting features shorter cycle times due to rapid cooling and re-solidification, but it incurs higher tooling, machinery, and control costs (both in terms of initial setup and with respect to continuous needs for increased calibration and maintenance) and can result in higher levels of porosity (because of the comparably faster cycle times). Despite these drawbacks, the ability to produce detailed, high-quality parts quickly makes high-pressure die casting a preferred method for automotive engine components, electronics housings, and various consumer goods.

But since the die cast nuclear waste ingots may be classified as non-precision castings that do not require stringent physical checks and tolerances due to the nature of field operations with respect to disposal within deep horizontal wellbores, gravity die casting is preferred over high pressure die casting in this patent application for manufacturing the composite spent nuclear fuel (SNF) assembly ingots (castings). Gravity die casting is suitable because it generates castings of sufficient external tolerances (for easy disposal in deeply located geologic repositories), with the desired internal monolithic characteristics (e.g., that minimize radionucleotide migration), and can do so at sufficient productions rates, all without the increased costs and increased complexity associated with the more expensive and more complex high pressure die casting methodology.

In this patent application, the term gravity inject, gravity feed, gravity pour, or the like, may be used interchangeably to specify a non-high pressure means of putting (forcing) the alloy melt into the die-mold (cavity). That is, gravity alone (and local atmospheric pressure) may be the only motive forces to force the alloy melt into the die-mold (cavity).

In this patent application, a gravity feed molten metal (copper) feed process may fill all (or substantially [mostly] all) the void spaces 301 with the gravity-fed molten alloy (with or without neutron absorbent material), which permeates the SNF assembly body completely (including its void spaces 301); and that gravity fed molten metal may then be in full contact with all parts of the SNF assembly including in its void spaces 301. In some embodiments, this process may allow for the neutron absorbing process to be active internally within and throughout the body of the SNF assembly including in its void spaces 301. The introduced melt alloy may also form a circumferential cylindrical enclosure (shroud) outside of and surrounding the SNF assembly. This solid circumferential cylinder (shroud) represents the volume external to the SNF assembly, and it also fills the mold cavity up to and inside the space internal to the mold's inside walls (interior surfaces). The resolidified finished body of copper, i.e., the casting, now resembles an “ingot” with a complete SNF assembly (or divided portions thereof) therein. This gravity die-cast molding process for treating SNF assemblies is a significant departure and improvement from prior art forms and allows for an increased level of extreme long-term ingot (casting) protection (e.g., over thousands of years). This ingot approach may provide SNF internal neutron absorbing capacity that is completely lacking in the prior art systems. This solid ingot approach may be able to withstand significantly higher external pressures as compared to prior art SNF disposal methods. This ingot approach is able to withstand significant high external pressures that may occur in some wellbores; whereas, prior art capsule (container) systems may have problems with. Further, with this ingot approach, because the internal void spaces 301 of the SNF assembly are now all of solid metal (with or without neutron absorbers), there is no place for water to intrude into the SNF assembly, become contaminated, and then distribute that contamination externally as the contaminated water finds its way out of a SNF assembly; and thus, handling, transportation, and/or general movement of the resulting ingot is much safer as compared to SNF assemblies under the prior art methods that are merely residing with capsules (containers).

Some technical problems to be solved by embodiments of the present invention are to overcome the defects of the prior art and to provide a SNF encapsulating process and method using gravity pouring die cast molding with metal alloys. With regard to this method, by gravity pouring die cast molding, the end product (casting [ingot]) is compact interiorly, with minimal, if any, pores formed, and the best quality and performance of the product may be guaranteed throughout the composite SNF assembly (ingot), which now forms part of a solid heterogeneous body.

The present invention provides a gravity die cast process method for molding using a metal alloy. In the molding process method, a gravity die-casting type machine may be used as the processing device, and accessory systems and devices may be used as the devices for preparing and delivering the melted alloy, which is poured into the mold wherein the SNF assembly (or portion thereof) resides.

There is a need for different and better methods of SNF encapsulation and disposal as compared to the prior art. See e.g., FIG. 2A to FIG. 2D for prior art approaches.

Based on the prior art's inherent shortcomings, there is a critical need for an effective, mechanically uncomplicated, safe, long-lasting, robust, rapidly implemented, repeatable, reliable, and economical method for disposing of SNF assemblies in castings (ingots). There is a need for effective casting (ingot) design and management. The new processes, methods, and/or the like taught herein precludes the need for all the expensive, time-consuming, and dangerous operations currently being used or contemplated to provide operational waste capsules.

An approach is needed that minimizes and/or foregoes the complex, sometimes unrealistic, and sometimes dangerous operational steps of the prior art. To solve the above-described problems, the present invention provides devices, apparatus, systems, methods, and/or the like for providing a novel casting (ingot) system for encapsulating nuclear waste, such as, but not limited to, HLW and/or SNF assemblies that have been and are continuing to accumulate on the surface.

The novel approaches taught as part of this patent application may provide devices, apparatus, systems, methods, steps, and/or the like wherein the HLW and/or SNF assemblies waste disposal operations may prepare the SNF for a more effective type of encapsulation prior to disposal in the underground disposal repository in deep (geologic/rock) formations.

It is to these ends that the present invention has been developed to dispose of HLW and/or SNF assemblies materials in underground deeply located human-made repository systems that can be effectively sealed off from the ecosphere by geological means and at great depths below the Earth's surface.

There is a need in the art for apparatus, systems, methods, steps, and/or the like that encapsulate SNF assemblies (or portions thereof), with molten (liquid) metal(s) and/or alloy(s) (such as, but not limited to, copper and/or copper alloy(s)), that may also penetrate substantially into all of the void spaces 301 within the SNF assemblies (or portions thereof) resulting in an output of a heterogenous ingot (casting) comprising both the poured metal(s)/alloy(s) and the SNF materials, and now with no internal void spaces. In some embodiments, the poured molten (liquid) metal(s) and/or alloy(s) may comprise neutron absorbing material(s).

It is to these ends that the present invention has been developed.

### BRIEF SUMMARY OF THE INVENTION

To minimize the limitations in the prior art and to minimize other limitations that will be apparent upon reading and understanding the present patent specification, various embodiments of the present invention may describe devices, apparatus, systems, processes, methods, steps, means, and/or the like for mechanical and/or physical modifications of nuclear waste forms, such as, but not limited to, spent nuclear fuel (SNF) assemblies (or portions thereof) for subsequent disposal within deeply located geologic repositories.

At least some embodiments of the present invention may describe devices, apparatus, systems, processes, methods, steps, means, and/or the like for processing and/or (long-term) disposing of nuclear (radioactive) waste. In some embodiments, nuclear waste, such as, but not limited to, spent nuclear fuel (SNF) assemblies or portions thereof, may be placed within diecast molds, and then gravity diecast molding may occur within the diecast molds and around the SNF assemblies or portions thereof that are emplaced within those diecast molds, with gravity poured molten alloy(s), to form solid metal ingots (castings) upon sufficient cooling, after the gravity pouring process has stopped. These metal ingots (castings) contain within the ingots (castings) the emplaced SNF assemblies or portions thereof. In some embodiments, the molten alloy(s) may contain a copper alloy. In some embodiments, the molten alloy(s) may also contain neutron absorbers. In some embodiments, the ingots (castings) may be placed into waste capsules. In some embodiments, the ingots (castings) and/or the waste capsules (with the ingots) may be landed (placed and/or inserted) in deeply located horizontal wellbores. In some embodiments, the deeply located horizontal wellbores may be at least partially located within deeply located geologic formations.

In some embodiments, devices, apparatus, systems, methods, steps, and/or the like may place at least one SNF assembly (or portion thereof) within a mold (cast and/or die); may then seal and/or close that mold (cast and/or die); and then introduce (pour) into that closed and sealed mold (cast and/or die), that is housing the SNF assembly (or portion thereof), molten (liquid) metal(s) and/or alloy(s) (such as, but not limited to, copper and/or copper alloy(s)), that by virtue of the gravity force; and that liquid (fluid) nature of the molten metal(s) and/or alloy(s) may also penetrate substantially into all of the void spaces within the SNF assembly (or portion thereof) resulting in an output of a heterogenous metal solid ingot (casting) comprising both the gravity poured metal(s)/alloy(s) in a resolidified state and the SNF materials (also in a solid state), and that now has no internal void spaces in the SNF materials (or in the ingot). In some embodiments, the introduced molten (liquid) metal(s) and/or alloy(s) may comprise neutron absorbing material(s).

In some embodiments, this gravity die casting (GDC) process (method) may involve (comprise) introducing molten metal alloys into a die cavity under gravity force. In some embodiments, at least some steps involved in this gravity pouring of metal alloys method (process) may be as follows: (1) die (mold) preparation; (2) die (mold) loading with the SNF; (3) die (mold) closing; (4) shot sleeve filling (maintaining); (5) gravity introduction (pouring); (6) cooling; (7) die (mold) opening; (8) ejection (removal) of the casting (ingot); (9) trimming and finishing of the removed casting (ingot); (10) inspection of the removed casting (ingot); (11) post-treatment of the removed casting (ingot) (if any); (12) quality control of the removed casting (ingot); portions thereof; combinations thereof; and/or the like.

In some embodiments, with respect to the die (mold) preparation step, the die (mold) may be prepared by cleaning and/or lubricating interior (internal) facing surfaces of the die (mold) to promote smooth molten metal flow and easy ejection (removal) of the casting (ingot).

In some embodiments, with respect to the die (mold) loading step, at least one SNF assembly (or portion thereof) may be loaded into the die (mold) cavity before the die (mold) is closed (sealed).

In some embodiments, with respect to the die (mold) closing step, the two (2) halves of the die (mold), a (stationary) half (die) and a (moving) half (cover), are closed together securely (e.g., by hydraulic means or the like means). Note, the “halves” of a given die (mold) are not necessarily geometric or dimensional halves; i.e., the “halves” may be of different sizes, dimensions, and/or geometry with respect to each other. Additionally, in some embodiments, a given die (mold) may have more than two (2) “halves.”

In some embodiments, with respect to the shot sleeve filling (maintaining) step, the shot sleeve, which acts as a reservoir for the molten metal(s) and/or alloy(s), may be at least partially (sufficiently) filled with the desired and/or predetermined molten (liquid) metal(s) and/or alloy(s) such that at least one complete casting (ingot) may be carried out. In some embodiments, the metal(s) and/or alloy(s) may typically be melted in a furnace before being transferred to the shot sleeve.

In some embodiments, with respect to the gravity introduction step (gravity pouring step), the shot sleeve may be manipulated to pour the molten metal(s) and/or alloy(s) into the die cavity through a sprue and runner (or the like) system. The gravitational force (local atmospheric pressure), high temperature, and molten (liquid/fluid) nature ensures rapid and complete filling of the cavity as well as into the void spaces within the SNF that is located within that cavity (mold [die]).

In some embodiments, with respect to the cooling step, after the gravity pouring, the formerly molten metal(s) and/or alloy(s) of the casting (ingot) start to resolidify as it cools below its melting point. In some embodiments, cooling channels within the die (mold) help expedite (speed up) this cooling and re-solidification process. In some embodiments, the cooling channels may be in physical communication with a heat exchanger configured to pull heat out of the die (mold).

In some embodiments, with respect to the die (mold) opening step, once the metal(s) and/or alloy(s) of the casting (ingot) have sufficiently resolidified (and/or attained a required [predetermined] strength), the die halves are opened.

In some embodiments, with respect to the ejection (removal) step, the newly formed (and sufficiently cooled) casting (ingot) may be removed from the die (mold). In some embodiments, with respect to the ejection (removal) step, ejector pins or other mechanical mechanisms may be used to push the casting (ingot) out of the die cavity; and/or material handling means (e.g., a robotic arm or the like) may be used to removably attach to the casting (ingot) to pull the casting (ingot) out of the die (mold) cavity. Removal (ejection) may be aided by gravity (e.g., by tipping the open die [mold]) and/or by a mold release agent having been previously applied to internal (interior) surfaces of the die (mold).

In some embodiments, with respect to the Trimming and Finishing step, excess material, such as flash or burrs, if any, may be removed from the casting (ingot) using trimming, cutting, and/or grinding tools and/or other mechanical finishing surface processes.

In some embodiments, with respect to the inspection step, the casting (ingot) may be inspected for any defects, dimensional accuracy, and/or adherence to (predetermined) quality standards.

In some embodiments, with respect to the post-treatment step, additional treatments may be (optionally) performed as needed and/or as desired, such as, but not limited to, heat treatment, surface finishing (e.g., shot blasting, polishing, coating), and machining, to achieve the desired properties and final product specifications. For example, and without limiting the scope of the present invention, a finished casting (ingot) should have an exterior surface that is generally smooth and free of exterior surface defects that may increase friction and/or be more likely to get caught as the casting (ingot) moves within a given wellbore. In some cases, a passivation process may be included to ensure long-term survivability of the casting (ingot) in the repository environment. This process may include a specialized chemical treatment process on the surface of the casting (ingot) which entails treating the ingot with special (predetermined) chemicals.

In some embodiments, with respect to the quality control step, the finished casting (ingot) may undergo a rigorous quality control inspection to ensure it meets any required standards before being inserted into a given wellbore and/or before being inserted into a capsule.

It's worth noting that the specific steps and/or details the taught gravity pouring of metal alloys method for use in disposing of radioactive waste, may vary depending on the: complexity of the SNF assembly (or portion thereof); complexity of the intended outputted casting (ingot); the chosen and/or selected metal(s) and/or alloy(s) for gravity pouring; the chosen and/or selected neutron absorbing material(s) to be mixed into the molten metal(s) and/or alloy(s), if any; the gravity die-cast equipment used; portions thereof; combinations thereof; and/or the like.

In some embodiments, a method for encapsulating SNF assemblies (or portions thereof) may comprise one or more of the following steps: (1) mounting a die (mold) (that is configured to receive at least one SNF assembly [or portion thereof]) onto a gravity die casting (molding) machine (press), cleaning that die (mold), spraying a mold release agent onto (interior and/or internal facing) surfaces of the die (mold) (e.g., with a sprayer), loading the at least one SNF assembly [or portion thereof]) into the open die (mold), and then closing that die (mold); (2) melting metal(s) and/or alloy(s) with a heating furnace (and/or other sufficiently hot heating means) and putting the molten (liquid) metal(s) and/or alloy(s) in a (heated) holding reservoir (e.g., shot sleeve) (wherein the metal(s) and/or alloy(s) may be copper and/or a copper alloy); (3) adding (and mixing) a neutron-absorbing material (such as, but not limited to, boron carbide [B₄C]) as needed and/or as desired to the molten (liquid) metal(s) and/or alloy(s) (e.g., within the holding reservoir); (4) introducing (pouring), under gravity, the melted molten metal(s) and/or alloy(s) (and neutron-absorbing material, if any) into the die (mold) of the die-casting machine, that also has the at least one SNF assembly (or portion thereof) located entirely within the die (mold); (5) gravity fed molding using the closed die-casting machine to form a casting (ingot) which may encase a SNF assembly (or portion thereof), wherein that casting (ingot) that looks and behaves like a solid cylindrical rod or “ingot” of metal(s) and/or alloy(s), then opening the die (mold) after the casting (ingot) has sufficiently cooled to be at least mostly (substantially) entirely solid, extracting the casting (ingot) out of the die (mold); portions thereof; combinations thereof; and/or the like.

In some embodiments, in the step (2), the step (4), and/or in the step (5) in the immediately preceding paragraph, the gravity die-casting machine may be a suitably configured die-casting machine with a die-casting temperature of at least 2,100 degrees Fahrenheit (° F.) to 2,282° F. Copper alloys may be formulated to have lower melting points compared to pure copper. By alloying copper with other metals and/or elements, the melting point of the resulting copper alloy may be significantly reduced for use in this process.

By implementing the above technical solution, the following beneficial practical effects may be accomplished. First, with regard to the gravity pouring process method for molding of a given SNF assembly (or portion thereof) of the present invention, the molded outputted product, i.e., the casting (or ingot) may be uniformly compact interiorly, with the best interior structure, and desired mechanical properties of the molded SNF product may be guaranteed. Second, with regard to the gravity pouring process method for molding of a given SNF assembly (or portion thereof) of the present invention, the molded outputted product, i.e., the casting (ingot) may be substantially (mostly) free of internal void spaces within the SNF assembly (or portion thereof) and as such the casting (or ingot) may be configured to withstand (i.e., without significant collapsing, deforming, and/or imploding) high exterior pressures and/or loads being placed upon the casting (ingot), such as, those that may be found within some wellbores. Third, with regard to the gravity fed pouring process method for molding of a given SNF assembly (or portion thereof) of the present invention, the molded outputted product, i.e., the casting (ingot) may be configured for significant neutron absorbing characteristics due to the presence of neutron absorbing material(s) being located within the former void spaces of the SNF assembly (or portions thereof), as well as, the presence of neutron absorbing material(s) being located around the exterior of the SNF assembly (or portions thereof) that is located within that casting (ingot). Fourth, with regard to the gravity pouring process for molding (die casting) of a given SNF assembly (or portion thereof) of the present invention, compared with the traditional (prior art) encapsulation methods, the new outputted castings (ingots) may be in a state or substantially close to being in a state to function and/or operate as an end-product that is configured to be inserted into a wellbore system for final disposal. Fifth, with regard to the gravity fed pouring mold process method for die-cast molding of molten alloys of the present invention, the gravity die-cast outputted end product, i.e., the casting (ingot), may be easily and/or readily handled, moved around, and/or transported; and easily and/or readily sequestered into available capsule transport and container systems without much reimagining and repurposing of current equipment.

At least some embodiments of the present invention may describe devices, apparatus, systems, methods, processes, steps, and/or the like for the modification and management of HLW nuclear waste, such as but not limited to SNF assemblies, which may then be sequestered (inserted) into deeply located geological repositories for final disposal (below water tables and entirely isolated from the ecosphere).

Additionally, at least some embodiments of the present invention may focus on satisfying a need to prepare the SNF assemblies (or portions thereof) for deep geological disposal in a manner that is safe, relatively cost-effective, timely (quick), and that allows for maximal disposal of radioactive waste materials.

At least some embodiments of the present invention may focus on mechanically and/or chemically modifying the SNF assemblies (or portions thereof) and then implementing the modified waste form (i.e., the casting [or ingot]) inside cylindrical waste capsule systems that are configured to receive the modified waste form. This modified waste form may be mechanically derived from existing SNF assemblies (or portions thereof) by utilizing gravity fed molten metal(s) and/or alloy(s) into and around a given SNF assembly (or portion thereof), that is disposed inside pre-designed molds, which allow for creating a fully formed solid SNF “ingot” that is devoid of void spaces.

At least some embodiments of the present invention differ from the prior art SNF management methods by one or more of the following: (1) a mechanical solidification operation on intact SNF assemblies (or a portion of a given SNF assembly); (2) producing waste castings (ingots) that are (substantially [mostly]) free of void spaces; (3) producing waste castings (ingots) that are configured to withstand significant (high) external pressures and/or loads because the waste castings (ingots) are (substantially [mostly]) free of void spaces; (4) producing waste castings (ingots) with significant neutron absorbing capabilities due at least in part to the waste castings (ingots) comprising neutron absorbing material(s) located within the former void spaces of the SNF assemblies (or portions thereof); (5) a molding process wherein in this process, the (SNF) waste is shaped and sized into (cylindrical) (structural) member that may be specifically configured to fit within existing (certified) waste capsules; a molding process that is gravity fed as opposed to being high pressure injected; and (7) encapsulation and disposal of the converted nuclear waste castings (ingots) into the waste capsules, which may then be emplaced within the deeply located horizontal (lateral) wellbores that may themselves located within deeply located geologic formations.

In some embodiments, it may be a requirement of at least one embodiment of the present invention that the disclosed and taught devices, apparatus, systems, methods, steps, and/or the like are capable of protecting the environment (ecosphere) from the deleterious effects of high nuclear waste disposal and waste migration away from the final disposal location.

It is an objective of the present invention to provide rapid processing and disposing of large volumes (e.g., on the order of thousands of metric tons) of waste (such as, but not limited to, HLW, SNF, portions thereof, combinations thereof, and/or the like) in relatively short periods of time as compared against prior art systems.

It is another objective of the present invention to provide processing and disposing of large volumes of waste (such as, but not limited to, HLW, SNF, portions thereof, combinations thereof, and/or the like) in a manner that is safe, timely, effective, cost effective, robust, repeatable, scalable, reliable, portions thereof, combinations thereof, and/or the like as compared against prior art systems.

It is another objective of the present invention to provide processing and disposing of large volumes of waste (such as, but not limited to, HLW, SNF, portions thereof, combinations thereof, and/or the like) in a manner that may be scalable to thousands of cycles per die (mold) and/or gravity die casting machine (press).

It is another objective of the present invention to modify SNF assemblies (or portions thereof) by introducing gravity fed molten (liquid) metal(s) and/or alloy(s) into the void spaces of the SNF assemblies (or portions thereof) and around the exteriors of the SNF assemblies (or portions thereof) to form waste castings (or waste ingots).

It is another objective of the present invention to generate waste castings (or waste ingots) that are (substantially [mostly]) free of internal void spaces within the SNF assemblies (or portions thereof) that are within the waste castings (or waste ingots).

It is another objective of the present invention to generate waste castings (or waste ingots) that are configured to have significant neutron absorbing capabilities by at least having neutron absorbing material(s) placed within the former void spaces of the SNF assemblies (or portions thereof) that are within the waste castings (or waste ingots).

It is another objective of the present invention to generate waste castings (or waste ingots) that are configured to withstand high (significant) external pressures, stresses, and/or loads by filling the former void spaces of the SNF assemblies (or portions thereof) that are within the waste castings (or waste ingots) with the resolidified metal(s) and/or alloy(s) from the high temperature molten (liquid) gravity fed die casting process.

It is another objective of the present invention to provide processing and disposal of waste, such as SNF assemblies, using multiple gravity die-casting injection processing systems in parallel, and/or in an assembly line fashion.

It is another objective of the present invention to dispose of waste (such as, but not limited to, HLW, SNF, castings (ingots), portions thereof, combinations thereof, and/or the like) within deeply located horizontal wellbores (note such a horizontal wellbore may be referred to as a SuperLAT); wherein at least a portion of the given horizontal wellbore may be located within a given deeply located geologic formation.

It is another objective of the present invention to dispose of waste, in different or multiple waste forms, within deeply located horizontal wellbores.

It is another objective of the present invention to provide novel means of modifying SNF assemblies to allow for disposal efficiently, timely, economically, and safely for final placement into cylindrical wellbore repositories.

It is another objective of the present invention to provide novel means of modifying SNF assemblies to minimize the effects of corrosion of the SNF material while in the disposal repository by completely protecting the parts of the SNF assembly both internally and externally by the corrosion-protective solidified alloy (metal).

It is another objective of the present invention to provide prepared waste material to be easily disposed of using the geometry of (existing) cylindrical wellbores without unnecessary experimentation and modifications.

It is another objective of the present invention to significantly reduce costs of SNF assembly disposal by modifying available economic means of processing the waste into novel forms for disposal that may be at least partially to mostly automated.

It is another objective of the present invention to provide underground waste storage in deep-closed geological systems, zones, and/or formations (rocks).

It is another objective of the present invention to implement deep geological disposal devices, apparatus, systems, methods, steps, and/or the like for the long-term disposal of HLW/LLW and/or derivatives, such as, but not limited to, spent nuclear fuel (SNF) assemblies and/or castings (ingots) into waste capsules and for disposal of solid wastes such as transuranic products or transuranic waste which is now disposed of in shallow near surface salt mines.

It is yet another objective of the present invention to allow the processing and disposal of large volumes (e.g., on the order of thousands of metric tons) of multiple waste forms waste (e.g., HLW in horizontal wellbores or SuperLAT systems) for disposal underground.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale to enhance their clarity and improve understanding of these various elements and embodiments of the invention. Furthermore, elements known to be common and/or well-understood to those in the industry are not necessarily depicted to provide a clearer view of the various embodiments of the invention(s). Some common items may be left off the drawings for clarity and ease of viewing. For example, and without limiting the scope of the present invention, in some instances, specific devices or apparatuses may not be shown in a given view. Still, it may be obvious to a person of ordinary skill in the relevant arts (technical fields) from the description that these items may be present and/or used in the given embodiment.

FIG. 1A is prior art and is a perspective view showing a Canadian model CANDU for a nuclear fuel assembly.

FIG. 1B is prior art and is a perspective view showing a (Russian) nuclear fuel assembly.

FIG. 1C is prior art and is a perspective view showing a U.S. nuclear fuel assembly.

FIG. 2A is prior art and is a perspective view showing a SKB spent fuel (SNF) canister and cradle assembly used in Finland and/or in Sweden.

FIG. 2B is prior art and is a perspective view showing a Canadian spent fuel (SNF) canister assembly for disposal in near-surface repositories.

FIG. 2C is prior art and is a front view showing U.S. (proposed/planned) operations where spent fuel (SNF) assemblies disposal is made in shallow mines or tunnel systems for disposal in near-surface repositories like Yucca Mt in Nevada.

FIG. 2D is prior art and shows a capsule for containment of spent nuclear fuel inserted in a pressure furnace for joining together a cover and a hollow cylinder by “hot isostatic pressing” (HIP); note, FIG. 2D of this present patent application is a prior art representation of a FIG. 1 from U.S. utility U.S. Pat. No. 4,209,420.

FIG. 3A is prior art and is a perspective view showing a generalized schematic of one type of SNF assembly showing at least some of its fuel rods and control rods (and with void spaces therebetween).

FIG. 3B is prior art and is a perspective view showing an inner schematic perspective view cross-section of a generic SNF fuel assembly, showing fuel rods and control rods and also showing free void spaces present in the SNF fuel assembly (e.g., around and in between the fuel rods and the control rods).

FIG. 4 depicts a two-dimensional (2D) schematic lengthwise cross-sectional view of a generalized gravity fed diecast system that may be used for generating (producing and/or outputting) the specialized ingots (castings), wherein the given ingot may comprise at least one SNF assembly or portion thereof within that given ingot.

FIG. 5A depicts a schematic lengthwise cross-section of a completed waste casting (waste ingot) after the gravity fed diecasting formation process and illustrating the SNF assembly (or portion thereof) located entirely within that completed waste casting (waste ingot).

FIG. 5B depicts a representational transverse width cross-section through a completed waste casting (waste ingot) after the diecasting formation process, showing the re-solidified metal(s) and/or alloy(s) surrounding and completely enclosing the SNF assembly (or portion thereof).

FIG. 5C is a partial exterior perspective view showing exterior surfaces of a portion of a completed waste casting (waste ingot) after the diecasting formation process.

FIG. 6 depicts a schematic lengthwise cross-sectional view of encapsulated at least one waste casting (waste ingot) implemented inside of a disposal capsule, wherein the disposal capsule may be configured for emplacement within a given deep wellbore (SuperLAT™) disposal system.

FIG. 7 shows a section (portion), in cross-section, through a deep wellbore (SuperLAT™) system that is configured to receive disposal capsules (with waste ingots located inside of the disposal capsules) within the wellbore(s).

FIG. 8 shows a flowchart of at least some steps in a method of forming and/or of disposing of waste castings (waste ingots), that may entirely contain SNF assemblies (or portions thereof), using high temperature, gravity fed molten metal (and/or alloy(s)) from gravity diecasting machinery and/or equipment; and/or within using wellbore(s) located in deep geologic formation(s).

FIG. 9 depicts a waste disposal repository system in which waste capsules (with ingots containing SNF assemblies [or portions thereof]) are sequestered in horizontal wellbore(s), wherein the horizontal wellbore(s) are located within deeply located geological formation(s).

FIG. 10 illustrates an example of a type of (relatively) small surface plaque (or the like) generally made of concrete (or the like) with a (brass) inscription plate, that may identify presence of a deeply located nuclear waste repository located below that plaque.

### REFERENCE NUMERAL SCHEDULE

101 (Canadian CANDU) nuclear fuel assembly 101
103 (Russian) nuclear fuel assembly 103
105 (U.S.) group (bundle) of nuclear fuel assemblies 105
106 nuclear fuel assembly 106
201 thick-walled and corrosion-resistant heavy copper cylindrical canister 201
203 cradle (scaffold) 203
205 SNF assembly 205
207 cover (lid) 207
209 final cover (lid) 209
211 thick-walled and corrosion-resistant heavy copper cylindrical canister 211
213 structural metal cylindrical canister 213
215 end cap (end plug) 215
221 tunnel 221
223 tunnel wall 223
225 titanium drip shield 225
227 tunnel floor 227
301 void space 301
303 fuel rod 303
305 control rod 305
307 base (support structure) 307
400 gravity fed diecasting system for producing ingots with SNF assemblies therein 400
403 die (mold) 403
405 gravity fed components 405
407 melt furnace/reservoir 407
409 molten/liquid metal(s) and/or alloy(s) (molten composition) 409
410 heating means (heater) 410
411 flow port 411
413 feed port 413
417 neutron absorber material 417
421 neutron absorber reservoir 421
423 connector tube(s) neutron absorber 423
425 gas cylinder 425
426 gas (purge) line 426
427 robotic handler 427
428 ejector pin(s) 428
429 cooling means (e.g., cooling bath) or passivation bath 429
431 controller 431
433 volume in die (mold) 433
435 release agent 435
437 outlet port (connector tube) 437
439 outlet reservoir 439
441 support 441
443 vent 443
500 ingot or casting (with SNF assembly [or portion thereof]) 500
501 exterior surface (of ingot/casting) 501
503 minimum thickness of ingot to SNF 503
506 modified SNF assembly (or portion thereof) 506
600 waste disposal capsule 600
601 common central axis 601
603 plate (for neutron absorption) 603
605 metal tube (pipe) 605
607 pipe coupling 607
609 sleeve (for neutron absorption) 609
611 support (standoff) 611
700 waste disposal system using deeply located wellbore(s) 700
701 string (of connect waste capsules) 701
703 wellbore 703
705 deeply located geologic formation 705
800 method of processing SNF assemblies (or portions thereof) for disposal 800
801 step of collecting, selecting, and/or gathering SNF assemblies (or portions thereof) 801
803 step of determine free (void) volume of a SNF assembly (or portion thereof) 803
805 step of selecting metal(s) and/or alloy(s) 805
807 step of determining volume of metal(s) and/or alloy(s) 807
809 step of performing criticality analysis on planned ingot with SNF (or portion thereof) 809
811 step of melting metal(s) and/or alloy(s) 811
813 step of building or re-using die mold 813
814 step of collecting and transferring melted materials into container 814
815 step of selecting and determining neutron absorber amount 815
816 step of adding neutron absorber 816
817 step of (optional) preheating of SNF assembly (or portion thereof) 817
818 step of inserting SNF assembly (or portion thereof) into die (mold) 818
819 step of looping insertion operations 819
821 step of adding release agent(s) into casting chamber (mold) 821
823 step of (optional) injecting (inert) gas into die (mold) 823
825 step of gravity pouring melted materials into loaded & closed die (mold) 825
827 step of cooling and removing ingot (casting) from die (mold) 827
829 step of (optional) passivating ingot (casting) 829
831 step of loading ingots into waste capsules 831
833 step of building (constructing) wellbore(s) system(s) 833
835 step of inserting waste capsules into wellbore(s) within deep geological formation(s) 835
837 step of sealing (closing) (loaded) wellbore(s) system(s) 837
900 waste disposal system using deeply located horizontal wellbore(s) 900
901 horizontal (lateral) wellbore(s) 901
903 vertical wellbore(s) 903
905 terrestrial (Earth) surface 905
907 drilling rig 907
911 nuclear power generation reactor plant 911
913 infrastructure building or structure 913
915 plug 915
1001 surface plaque 1001
1003 nominal dimensions (of surface plaque) 1003
1005 inscription plate 1005
1007 trees (tree line) 1007

### DETAILED DESCRIPTION OF THE INVENTION

In this patent application, the term “HLW” refers to high-level nuclear waste, which is radioactive. In this patent application, the term “SNF” refers to spent nuclear fuel and is a type of (a subcategory of) HLW. In this patent application, the terms “HLW” and “SNF” may be used interchangeably.

In this patent application, the terms “wellbore” and “borehole” may be used interchangeably. Note, unless “wellbore” is prefaced with “vertical,” “horizontal,” or “lateral,” then use of “wellbore” alone may refer to a vertical wellbore, a horizontal wellbore, a lateral wellbore, and/or a combination of such wellbore types.

In this patent application, the terms “capsule,” “carrier tube,” and/or “canister” may be used interchangeably with the same meaning referring to a capsule that is configured to house, hold, and/or retain waste therein, such as, but not limited to, nuclear waste, radioactive waste, HLW, SNF, SNF assemblies, castings, ingots, portions thereof, combinations thereof, and/or the like.

In this patent application, the terms “die-cavity,” “die cavity,” and/or “cavity,” may be used interchangeably to refer to the three-dimensional (3D) volume (space) in which the SNF assembly (or portion thereof) may temporarily reside within during the gravity fed die casting formation operations; whereas, the terms “die” and/or “mold” may be used interchangeably to refer to the overall structure that may be configured to receive the SNF assembly (or portion thereof) during the gravity fed die casting formation operations.

In this patent application, the terms “gravity fed,” “gravity injection,” “gravity introduction,” and/or “gravity pour,” may be used interchangeably to refer to the introduction (feeding and/or pouring) of a hot liquid melt alloy (or metal) into a die-cavity under the effects of gravity (and/or at local atmospheric pressure).

In this patent application, the terms “tube,” “cylinder,” and “pipe” may be used interchangeably to refer to cylindrical elements (sections and/or portions) implemented in the design, installation, and/or construction processes of lining and/or forming wellbores.

In this patent application, the terms “ingot” and/or “casting” may be used interchangeably to refer to the solid three-dimensional (3D) outputs, of generally cylindrical elements (members), formed by the gravity fed die casting process taught herein, such a casting (and/or ingot) may entirely contain (house) a given SNF assembly (or portion thereof).

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized, and changes may be made without departing from the scope of the invention.

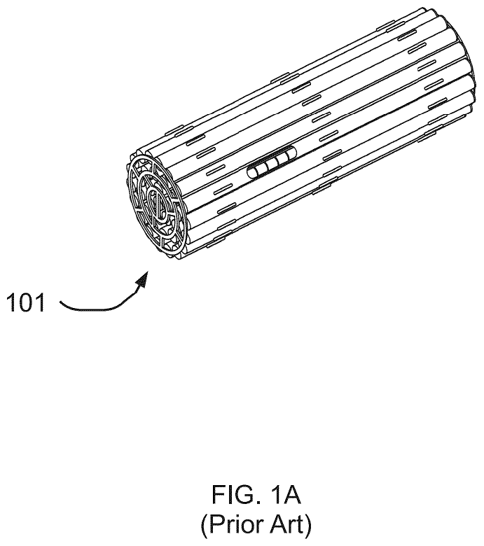

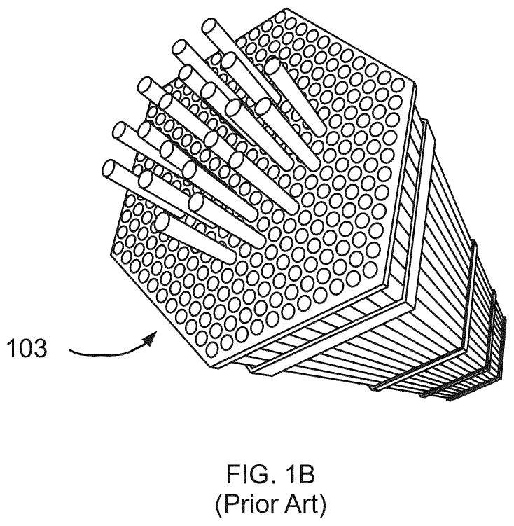

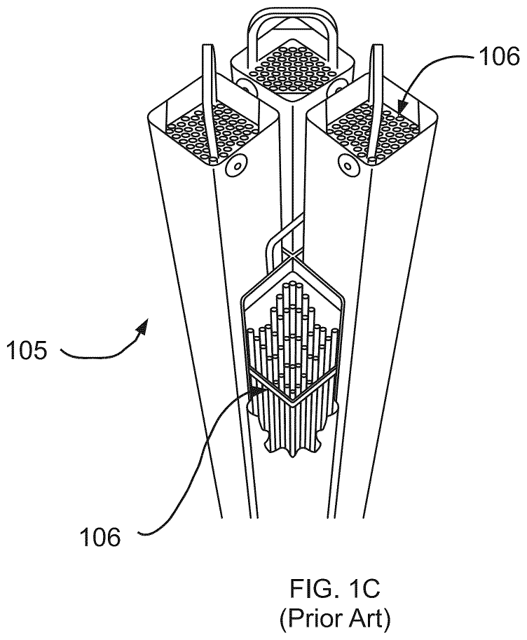

FIG. 1A is prior art and shows a Canadian model CANDU for a nuclear fuel assembly 101.

FIG. 1B is prior art and shows a Russian nuclear fuel assembly 103.

FIG. 1C is prior art and shows a group or bundle of U.S. nuclear fuel assemblies 105, with a plurality of single SNF assembly 106 being part of that bundle 105.

FIG. 1A, FIG. 1B, and/or FIG. 1C may collectively illustrate types of prior art preexisting and current nuclear fuel assemblies 101, 103, 105, and 106, at least used in Canada, Russia, and the U.S., respectively. These nuclear fuel assemblies 101, 103, 105, and 106, vary in size and shape in actual practice and have been specifically designed to optimize performance during power generation. Some nominal dimensions of these types of nuclear fuel rod assemblies 101, 103, 105, and 106, may be as follows: (a) square or rectilinear fuel rod assemblies 106 are usually between four (4) meters (m) to five (5) meters in length and about fourteen (14) centimeters (cm) to twenty-two (22) cm in cross-section; and (b) nominal dimensions of the circular/cylindrical fuel rod assemblies 101 are about fifty (50) cm long and about ten (10) cm in cross-section. In any event, as these nuclear fuel assemblies 101, 103, 105, and 106, are prior art and existing, the precise dimensions and geometries are known.

Note, if the given nuclear fuel assembly of FIG. 1A, FIG. 1B, and/or of FIG. 1C is “spent,” then such a nuclear fuel assembly may be of a particular type of spent nuclear fuel (SNF) assembly.

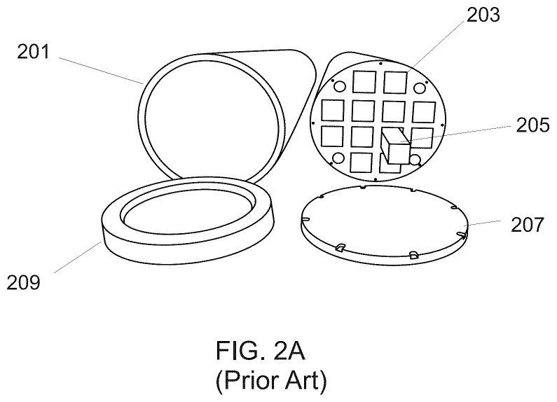

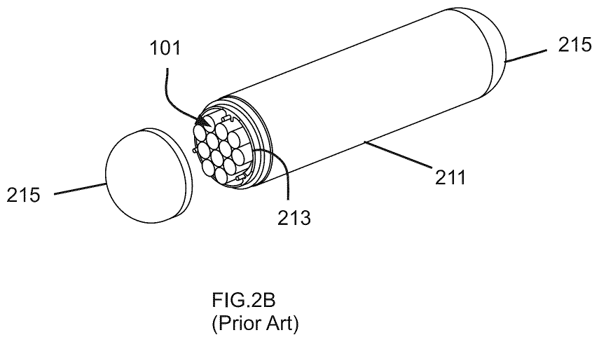

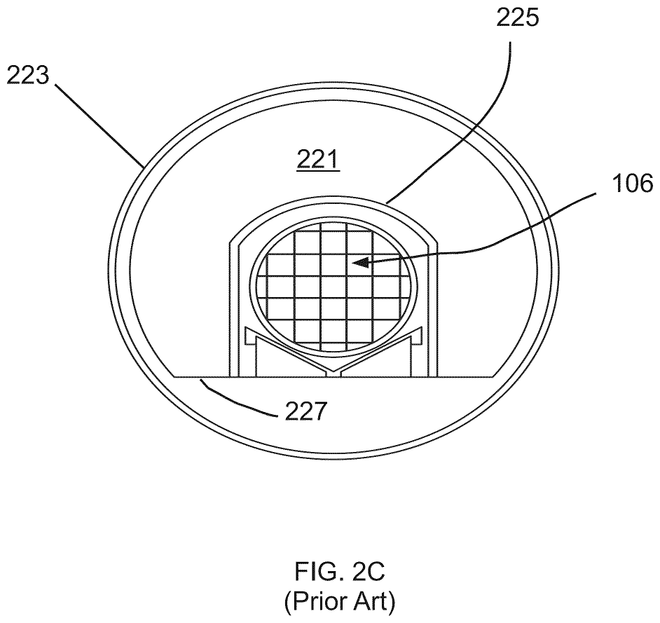

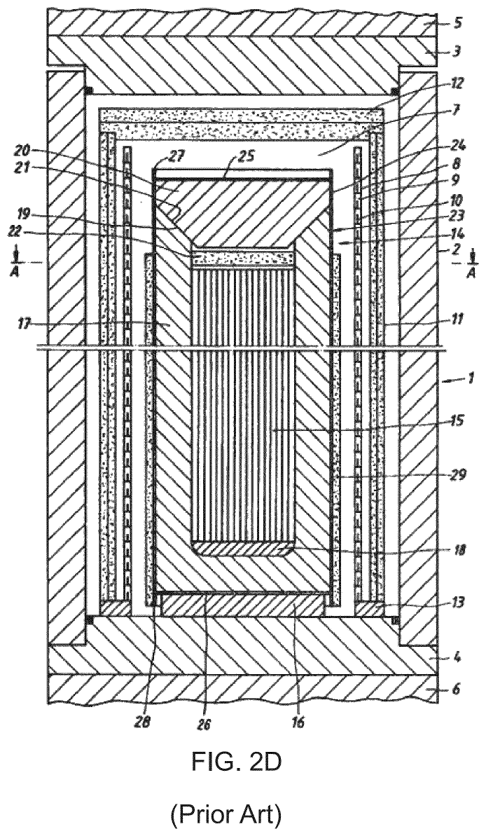

In prior art technology and operations, prior approaches to treating SNF assemblies are taught, at least some of which are depicted in FIG. 2A, in FIG. 2B, and in FIG. 2C.

FIG. 2A is prior art and shows a SKB spent fuel (SNF) canister 201 and cradle 203 assembly used in Finland and in Sweden. The prior art SNF waste disposal approach taught in Finland (and Sweden) utilizes a set of SNF assemblies 205 that are emplaced in a structural cast iron honeycomb cradle 203 (scaffold 203) supporting structure. The cradle 203 with its held set of SNF assemblies 205 are capped with a cover (lid) 207. Then this composite structure (e.g., the cradle 203 with its held set of SNF assemblies 205 and the cover 207) are enclosed in a very thick-walled and corrosion-resistant heavy copper cylindrical canister 201. Canister 201 (along with its holdings) is then closed with a final cover (lid) 209. Then the massive copper cylindrical canister 201 along with its contents (e.g., of the cradle 203 that is holding the SNF assemblies 205), is then disposed of in vertical shafts implemented by drilling a “shallow” borehole in a floor of a tunnel or mine repository. See e.g., FIG. 2A.

FIG. 2A illustrates a prior art process for handling and packaging of SNF assemblies 205. FIG. 2A illustrates the “SKB” process practiced in Finland and/or in Sweden in which the SNF assemblies 205 that have been removed from cooling ponds (e.g., at nuclear power generation plants or from other [surface] storage systems) are stored first in a cast iron honeycomb structure 203 (cradle 203). The SNF assemblies 205 and the cast iron cradle 203 are then enclosed inside a massive, flanged copper cylinder 201, forming a disposal capsule 201. This disposal capsule 201 is more than three (3) feet in diameter and with walls of at least two (2) inches in thickness. A full capsule 201 system may weigh more than 24,460 pounds (lbs.) when loaded with SNF assemblies 205. This prior art capsule 201 disposal system is then sequestered in small disposal holes drilled vertically in the floor of a disposal tunnel of a near-surface repository. Loading of these filled capsules 201 underground requires a complex of rails, trucks, transports, and heavy equipment insertion devices that must operate within confined areas excavated in more than thirty-one (31) miles of in near surface tunnels. This prior art approach is essentially establishing a small village underground.

FIG. 2B is prior art and shows a Canadian spent fuel (SNF) canister 211 assembly for disposal in near-surface repositories. This prior art approach for SNF disposal, published in Canada, bundles the individual SNF assemblies 101 into a generally cylindrical bundle of SNF assemblies 101, wherein the bundle then gets emplaced inside a structural metal cylindrical canister 213 and then this structural metal cylindrical canister 213 (with the bundle of SNF 101 assemblies) gets enclosed completely inside a protective massive copper canister 211 with end caps 215 which are friction welded to the original copper cylinder canister 211 member. See e.g., FIG. 2B.

FIG. 2B illustrates a prior art process for handling and packaging of SNF assemblies 101. FIG. 2B illustrates the SNF assemblies 101 capsule 211 disposal process currently practiced in Canada in which the SNF assemblies 101 that have been removed from cooling ponds (at the nuclear power generation plants or from other [surface] storage systems) are stored in a metal container 213 with a copper cap(s) 215 thus forming a disposal capsule 211. The Canadian capsule 211 system is about 2.5 meters (m) long, 0.4 m to 0.6 m in diameter, and with a copper wall thickness of three (3) millimeters (mm). A filled disposal capsule 211 may weigh about 2.8 metric ton (mt) and is buried and stored in a near surface waste repository in which a small “grave-like burial cavity” is excavated transversely in a floor of a near surface disposal tunnel.

FIG. 2C is prior art and shows U.S. (proposed and/or planned) operations where spent fuel (SNF) assemblies 106 disposal is made in shallow mines or tunnel systems for disposal in near-surface repositories like Yucca Mt in Nevada. This prior art approach, published in the U.S., teaches the emplacement of groups 105 of SNF assemblies 106 as integral waste packages on a rail-type system inside a near-surface (e.g., 300 meters [m] below terrestrial surface) tunnel 221 that is unrealistically and dangerously placed above the local water table. The tunnel 221 is surrounded along its length by a tunnel wall 223. The nuclear waste capsule packages are then expected to be protected by a set of titanium drip shields 225 which are supposed to be installed sometime in the future, after complete waste emplacement. It is hoped that these titanium “umbrellas” 225 can unrealistically protect the emplaced waste 105/106 from vertically migrating groundwater for 10,000 years. Tunnel floor 227 is a floor of such a tunnel. Interaction with the local water table should cause undesired and dangerous regular migration of radionucleotides away from and out of the intended repository. See e.g., FIG. 2C.

FIG. 2D of this present patent application is a prior art representation of a FIG. 1 from U.S. utility patent 4209420. FIG. 2D of this present patent application shows a prior art operation where spent fuel (SNF) assemblies are embedded in a solid composite matrix by a process called “hot isostatic pressing” (HIP). The process involves placing the waste material, mixed with glass or ceramic, into a sealed container. This container is then subjected over a prolonged period of time to high temperatures and high pressures in a specialized HIP furnace. This system essentially behaves like a high temperature closed high pressure cooker in common use. The hot isostatic pressing (HIP) process for nuclear waste encapsulation typically requires several hours or more to complete. The exact duration can vary depending on the specific materials and waste form being processed, but it generally ranges from two (2) to twenty-four (24) hours per cycle. This time frame includes the heating period to reach the desired temperature, the holding period at high temperature and pressure to ensure complete densification, and the cooling period. The precise parameters are carefully controlled. The combination of heat and isostatic pressure causes the material to densify, eliminating voids and creating a solid, monolithic structure. This dense form minimizes the potential for radioactive leakage and enhances the long-term stability and safety of the waste form, making it suitable for secure, deep geological disposal.

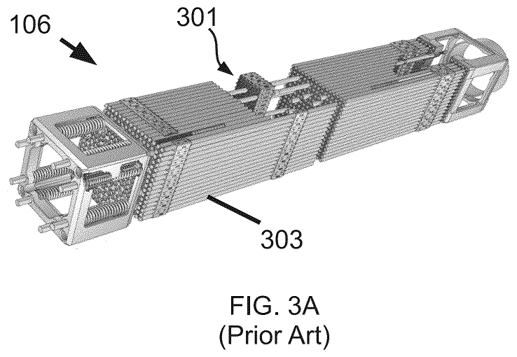

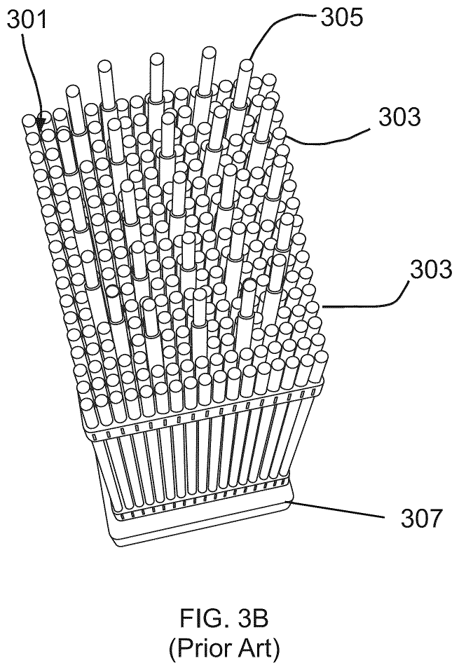

FIG. 3A is prior art and depicts an isometric (perspective) generalized schematic of one type of SNF assembly 106 showing at least some of its fuel rods 303, control rods 305 (see FIG. 3B for use of reference numeral 305), and with void spaces 301 (internal void spaces 301) therebetween. FIG. 3A shows an isometric rendering of a generic United States (U.S.) SNF assembly 106. This FIG. 3A illustration shows the geometry and construction of the fuel rods 303 and the control rods 305 and the structural elements of the SNF assembly 106.

FIG. 3B is prior art and shows an inner schematic perspective view cross-section of a generic SNF fuel assembly 106, showing its fuel rods 303, control rods 305, and with void spaces 301 present in the assembly. FIG. 3B illustrates an isometric (perspective) graphic of a partial typical U.S. SNF assembly 106. FIG. 3B shows the fuel rods 303 and the moderator or control rods 305 on a SNF base 307. The spatial geometry of the SNF assembly 106 illustrates the distribution of solid cylindrical elements and available void spaces 301 within the body or matrix of these SNF 106 assemblies. There is considerable free space, porosity, or voids 301 between and around the collective internal structural elements (such as, fuel rods 303, control rods 305) that make up an SNF assembly 106. This internal intricate void space 301, of a typical SNF assembly 106 (or of any presently known SNF assembly), may be easily and readily determined by a number of well-known techniques. For example, and without limiting the scope of the present invention, this internal intricate void space 301, of a typical SNF assembly 106 (or of any presently known SNF assembly), may be easily and readily determined from digital 3D modeling software used to model a given SNF assembly 106. For example, and without limiting the scope of the present invention, this internal intricate void space 301, of a typical SNF assembly 106 (or of any presently known SNF assembly), may be easily computed empirically by a liquid displacement process on a given finished SNF assembly 106.

This availability feature of void spaces 301 may be exploited in the novel gravity fed diecasting process taught herein, in which these internal voids 301 are filled with melted (molten) metal(s) and/or alloys 409 during the gravity fed diecasting process, to provide a novel protected disposal ingot 500 that includes a given SNF assembly 106 (or portion thereof) and the molten composition 409 as a single solid heterogenous matrix, with the void space 301 at least substantially (mostly) filled with the metallic alloys 409, even down to the microscopic level. In some embodiments of the present invention, this internal intricate void space 301, of a typical SNF assembly 106 (or of any presently known SNF assembly), may be intended to be at least substantially (mostly) filled with at least molten liquid metal(s) 409 and/or alloy(s) 409 during a gravity fed diecast molding operating around an entirety of a given SNF assembly or a portion of that given SNF assembly.

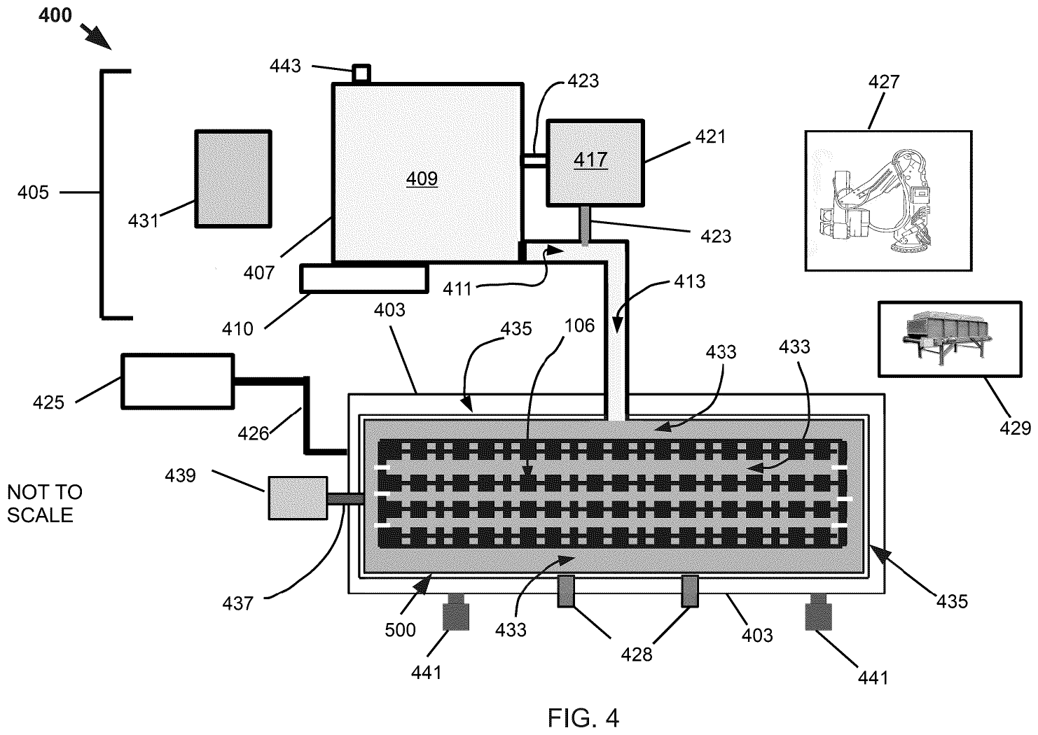

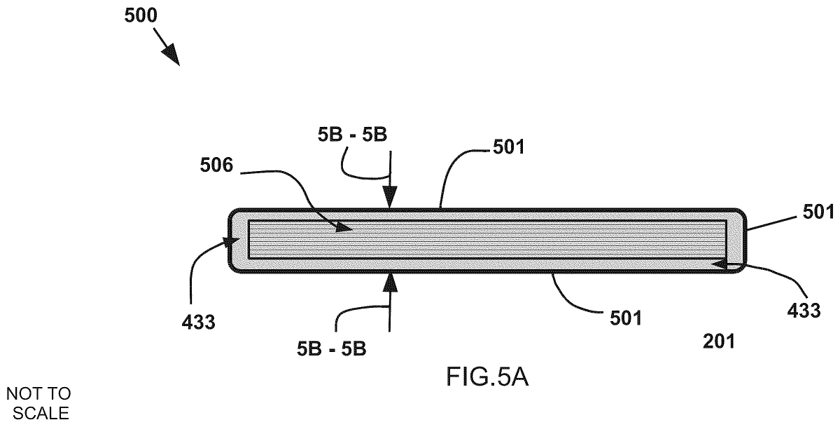

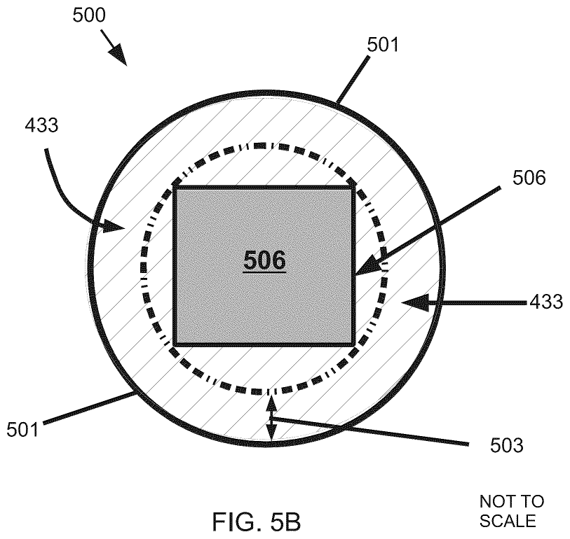

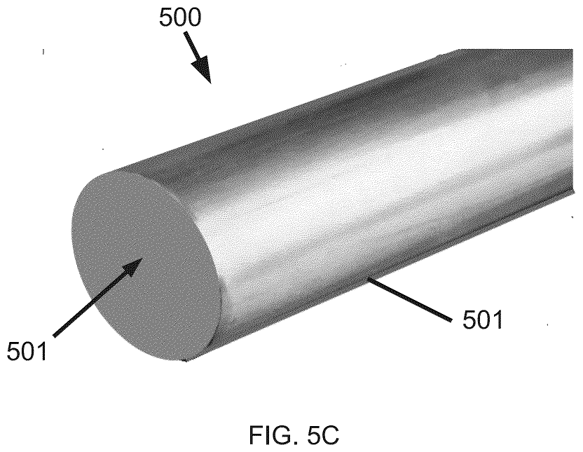

FIG. 4 is a generalized view showing a typical gravity fed diecast molding system 400 for generating (producing and/or outputting) ingots 500 (castings 500), wherein a given ingot 500 may comprise at least one SNF assembly or portion thereof within the given ingot 500. Note, a given ingot 500 (or a portion thereof) is shown in FIG. 5A, in FIG. B, and/or in FIG. 5C. FIG. 4 depicts a two-dimensional (2D) schematic lengthwise cross-sectional view of a generalized gravity diecast system 400 used for generating (producing and/or outputting) ingots (castings) 500, wherein the given ingot 500 may comprise at least one SNF assembly 106 or portion thereof within that given ingot 500. FIG. 4 may show inside of a closed die (mold) 403. In some embodiments, when die (mold) 403 has been closed with a given SNF assembly 106 (or portion thereof) located entirely inside of that closed die (mold) 403, then that given SNF assembly 106 (or portion thereof) may be entirely disposed within that closed die (mold) 403 as shown in FIG. 4. In some embodiments, closed die (mold) 403 may entirely surround a given (and predetermined) volume 433 within that closed die (mold) 403. In some embodiments, volume 433 may be configured to entirely house (hold [retain]) a given SNF assembly 106 (or portion thereof). In some embodiments, any void spaces within volume 433, such as, but not limited to, void space 301 and any space between interior surfaces of die (mold) 403 and exterior surfaces of the housed SNF assembly 106 (or portion thereof), may be configured to be at least substantially (mostly) filled with liquid (molten) medium 409 during gravity fed operations of gravity fed diecasting components 405 and with die (mold) 403 closed.

Continuing discussing FIG. 4, in some embodiments, a given gravity fed diecast molding system 400 may comprise at least one of: a die (mold) 403, gravity fed components 405, a robotic handler 427, a cooling bath 429 (passivation bath 429), a controller 431, a portion thereof, combinations thereof, and/or the like. In some embodiments, a given gravity fed diecast molding system 400 may comprise die (mold) 403 and gravity fed components 405. In some embodiments, die (mold) 403 may be configured to entirely house at least one SNF assembly 106 or a portion thereof (or some other SNF assembly or portion thereof). In some embodiments, die (mold) 403 may be in at least two separable parts (halves) (such as, but not limited to, a fixed half and a movable half).

Continuing discussing FIG. 4, in some embodiments, the gravity fed components 405 may be configured to gravity feed a liquid (and/or molten) medium 409 into volume 433 within closed die (mold) 403 from a melt furnace and/or reservoir 407. In some embodiments, gravity force may provide the motive means for feeding (pouring) liquid (and/or molten) medium 409 from melt furnace and/or reservoir 407 and into closed die (mold) 403. In some embodiments, during active gravity feeding (pouring) operations, when die (mold) 403 may be closed (and holding a SNF assembly 106 [or portion thereof]) the operatively connected gravity fed components 405 may introduce (feed [pour]) liquid (molten) medium 409 from melt furnace 407 and/or reservoir 407 and into closed die (mold) 403, to (substantially [mostly]) fill all aforementioned void spaces within volume 433 (including void spaces 301) and producing ingot 500 (casting 500) once that introduced medium 409 has cooled sufficiently to resolidify. At the end of the gravity feeding and solidification process, the SNF assembly 106 (or portion thereof) and the melt material 409 may form a single composite mass, that is heterogenous, and that is herein referred to as an “ingot” (e.g., ingot 500) and/or as a casting (e.g., casting 500), in this patent application.

Continuing discussing FIG. 4, in some embodiments, gravity fed components 405 may comprise melt furnace and/or reservoir 407. In some embodiments, gravity fed components 405 may comprise melt furnace and/or reservoir 407, flow port 411 and/or feed port 413. In some embodiments, gravity fed components 405 may comprise melt furnace and/or reservoir 407, flow port 411, feed port 413, neutron absorber reservoir 421, port for neutron absorber 423, portions thereof, combinations thereof, and/or the like. In some embodiments, gravity fed components 405 may comprise melt furnace and/or reservoir 407 and controller 431. In some embodiments, gravity fed components 405 may comprise melt furnace and/or reservoir 407, flow port 411, feed port 413, neutron absorber reservoir 421, port for neutron absorber 423, controller 431, portions thereof, combinations thereof, and/or the like.

Continuing discussing FIG. 4, in some embodiments, at least some of gravity fed components 405 may be located vertically above die (mold) 403. In some embodiments, at least most of melt furnace and/or reservoir 407 may be located vertically above die (mold) 403. In some embodiments, the melt reservoir 407 may be vertically elevated, with respect to die (mold) 403, to provide a higher (greater [larger]) hydraulic head and/or increased flow rate of the melt 409 into volume 433.

Continuing discussing FIG. 4, in some embodiments, reference numeral “409” may be associated with interchangeable terminology of “molten composition,” “molten materials,” “molten metal(s),” “molten alloy(s),” “molten copper,” “molten copper alloy(s),” “melt,” portions thereof, combinations thereof, and/or the like. Further, “molten” may be replaced and/or interchanged with “melted” in this context. Further still, while molten composition 409 may be molten and/or melted, molten composition 409 may behave like a fluid and/or a liquid; and once composition 409 has sufficiently cooled, then composition 409 may no longer by molten, melted, liquid, and/or fluid and may instead be solid (resolidified) and/or behave as a solid. In some embodiments, medium 409 may comprise at least one: metal, alloy, neutron absorber, portions thereof, combinations thereof, and/or the like. In some embodiments, the metal and/or the alloy of medium 409 may be at least partially or at least substantially (mostly) of copper. In some embodiments, liquid (molten) medium 409 may or may not include the neutron absorber(s). In some embodiments, gravity fed diecasting system 400 and/or gravity fed components 405 may additionally comprise (a predetermined volume of) composition 409. See e.g., FIG. 4 for molten composition 409.

Continuing discussing FIG. 4, in some embodiments, melt furnace/reservoir 407 may be a container that is configured to house, hold, and/or retain a predetermined volume of molten composition 409 and/or to maintain a predetermined volume of molten composition 409 it a molten, melted, and/or liquid state. In some embodiments, the predetermined volume of reservoir 407 may be of a volume sufficient to fill volume 433 of die (mold) 403. In some embodiments, melt furnace and/or reservoir 407 may be configured to house (hold) medium 409, with or without neutron absorber(s). In some embodiments, reservoir 407 may be operatively connected to a heating means 410 for heating reservoir 407 to maintain molten composition 409 in its molten, melted, and/or liquid state. In some embodiments, melt furnace and/or reservoir 407 may be operatively fitted with one or more heaters 410. In some embodiments, heating means 410 and/or heaters 410 may be one or more of: electric resistive heaters, inductive heaters, combustion based heaters, laser based heaters, plasma based heaters, a portion thereof, combinations thereof, and/or the like. In some embodiments, during gravity fed operations of system 400 and/or of gravity fed components 405, medium 409 may be maintained in a molten, liquid, and/or fluid state within melt furnace and/or reservoir 407. In some embodiments, melt furnace and/or reservoir 407 may be heated to melt and/or liquify medium 409 within melt furnace and/or reservoir 407. In some embodiments, at least some liquid (molten) medium 409 may flow from melt furnace and/or reservoir 407 and into closed die (mold) 403 via at least one: flow port 411, feed port 413, portions thereof, combinations thereof, and/or the like. See e.g., FIG. 4.

Continuing discussing FIG. 4, in some embodiments, melt furnace and/or reservoir 407 may be operatively and physically connected (linked) to die (mold) 403 and/or to volume 433 via flow port 411 and/or via feed port 413. In some embodiments, flow port 411 and/or feed port 413 may be disposed between reservoir 407 and die (mold) 403. In some embodiments, flow port 411 and/or feed port 413 may run from reservoir 407 to die (mold) 403. In some embodiments, flow port 411 and/or feed port 413 may be configured to permit melt 409 from reservoir 407 to be gravity fed into volume 433. In some embodiments, flow port 411 and/or feed port 413 may be piping, pipes, conduit, spruces, defined fluid pathways, a portion thereof, combinations thereof, and/or the like that are configured to transport melt 409 from reservoir 407 and into volume 433. In some embodiments, flow port 411 may be a completely enclosed fluid path, as in a pipe or conduit from melt furnace and/or reservoir 407 to feed port 413, that is configured to facilitate movement of at least some liquid (molten) medium 409. In some embodiments, feed port 413 may be a completely enclosed fluid path, as in a pipe or conduit for facilitating movement of liquid (molten) medium 409 and leading into (closed) die (mold) 403 (and/or into volume 433). In some embodiments, flow port 411 and/or feed port 413 may be heated to help melt 409 be (and/or stay) in a molten state. In some embodiments, flow port 411 and/or feed port 413 may be insulated to reduce heat loss. In some embodiments, reservoir 407 may comprise flow port 411. See e.g., FIG. 4.

Continuing discussing FIG. 4, in some embodiments, melt furnace and/or reservoir 407 may comprise a vent 443 and/or a means to be locally open to the atmosphere. In some embodiments, vent 443 may be located in an upper and/or a top portion (region) of reservoir 407. In some embodiments, when vent 433 may be open, a vacuum (and/or negative pressure) may be prevented from setting up within reservoir 407, which in turn may facilitate the gravity fed flow of melt 409 out from reservoir 407 and into volume 433.

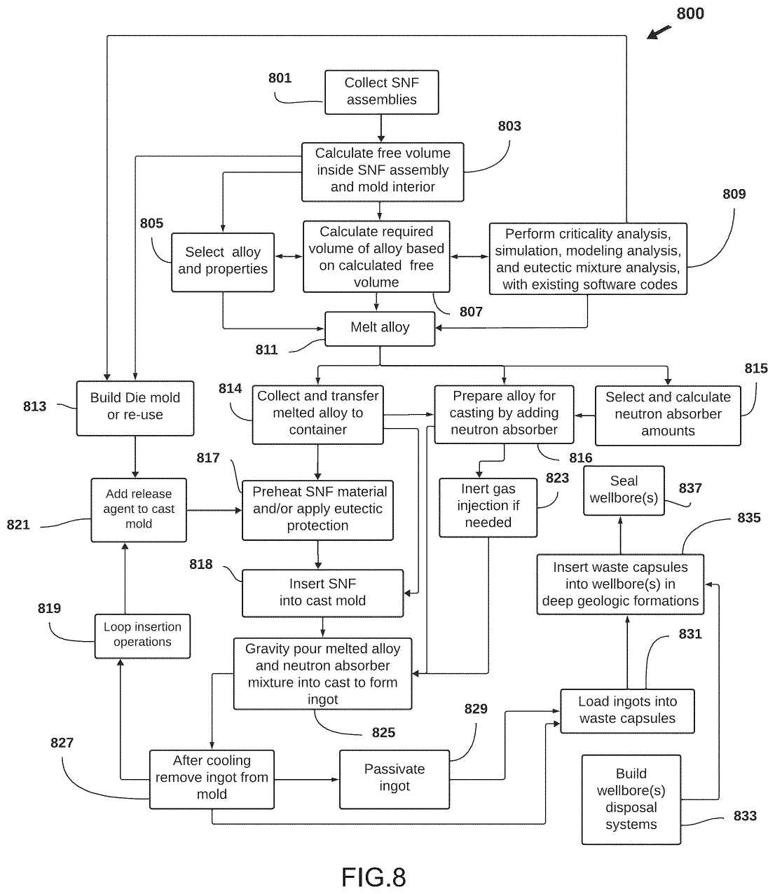

Continuing discussing FIG. 4, in some embodiments, gravity fed diecasting system 400 and/or gravity fed components 405 may comprise gas cylinder(s) 425 and/or gas line 426. In some embodiments, a gas within gas cylinder(s) 425 may be an inert gas with respect to medium liquid (and/or molten) medium 409. In some embodiments, a gas within gas cylinder(s) 425 may be nitrogen, argon, portions thereof, combinations thereof, and/or the like. In some embodiments, gas line 426 may fluidly link a given gas cylinder(s) 425 to (an interior of) mold 403. In some embodiments, gas line 426 may be a tube, tubing, a pipe, piping, a portion thereof, combinations thereof, and/or the like. In some embodiments, gas line 426 may provide a fluid (gas) pathway from gas cylinder(s) 425 to (an interior of) mold 403. In some embodiments, gas cylinder(s) 425 and/or gas line 426 may enable and/or support a step 823 of method 800 (see e.g., FIG. 8 and its below discussion).

Continuing discussing FIG. 4, in some embodiments, robotic handler 427 may be configured for (automatically) loading a given SNF assembly 106 (or portion thereof) into the open die (mold) 403; unloading, ejecting, and/or extracting a newly formed ingot 500 from open die (mold) 403; moving a newly unloaded and/or extracted ingot 500 from open die (mold) 403 and into cooling bath 429 (passivating bath 429); moving a now cooled ingot 500 from out of cooling bath 429; portions thereof; combinations thereof; and/or the like. In some embodiments, robotic handler 427 may be at least one robotic arm. In some embodiments, robotic handler 427 may be remotely operated by a human, a computer, a controller (e.g., controller 431), and/or an AI (artificial intelligence) operator; and/or robotic handler 427 may be programmed to operate autonomously. In some embodiments, distal terminal end(s) of robotic handler 427 may comprise at least one of: a suction means for picking up and/or holding SNF assembly 106 (or portion thereof) and/or ingot 500; physical manipulator(s) (e.g., claw, hand, grabber, and/or the like) for picking up and/or holding SNF assembly 106 (or portion thereof) and/or ingot 500; portions thereof; combinations thereof; and/or the like.

In some embodiments, robotic handler 427 may be a component of an ejection means. In some embodiments, the ejection means may be configured for unloading, ejecting, and/or extracting a newly formed ingot 500 from open die (mold) 403. In some embodiments, the ejection means may comprise robotic handler 427, ejector pin(s) 428, portions thereof, combinations thereof, and/or the like. In some embodiments, the ejector pin(s) 428 may be ejector rod(s) and/or the like. Prior art teachings of die cast mold ejector pins and/or other ejection means are incorporated by reference herein.

Continuing discussing FIG. 4, in some embodiments, cooling bath 429 may be configured to cool, quench, and/or passivate ingot 500. In some embodiments, cooling bath 429 may be configured to more quickly lower temperatures of ingot 500 once ingot 500 leaves die (mold) 403. In some embodiments, cooling bath 429 may be at least partially filled with a cooling medium, such as, but limited to, a predetermined liquid and/or a predetermined fluid. In some embodiments, cooling bath 429 may be at least partially filled with water, oil, additives, portions thereof, combinations thereof, and/or the like.

In some embodiments, passivating bath 429 may be at least partially filled with a passivation medium, such as, but limited to, a predetermined liquid and/or a predetermined fluid.

Continuing discussing FIG. 4, in some embodiments, gravity fed diecasting system 400 and/or gravity fed components 405 may additionally comprise (a predetermined volume of) neutron absorber material 417. In this patent application, a typical neutron absorber (such as, neutron absorber material 417) may be boron carbide (B₄C) which can be utilized as a powder and/or as fine particles. This powder (particles) is commercially available in sizes down to particles of five (5) microns (plus or minus 2 microns)—which is (significantly) smaller than the void spaces 301. This boron carbide (B₄C) neutron absorber powder may be blended with the melted alloy 409 since its melting point (2,445 degrees Celsius [° C.]) is much higher than the contemplated melt alloy copper 409 (which may be around 1,084 degrees Celsius [° C.] or so). The boron carbide (B₄C) combined with the melt alloy 409 forming a continuous mix, when introduced into the die (mold) 403, and added and dispersed inside, which then solidifies as an ingot 500. Boron carbide (B₄C) acts as a neutron absorber, reducing the neutron flux and minimizing the risk of criticality, which refers to an uncontrolled nuclear chain reaction. In some embodiments, inclusion of one or more neutron absorber(s) into the melt alloy 409 may be important for increased and/or better safe handling and storage of spent nuclear fuel (SNF) and/or other radioactive waste materials. See e.g., FIG. 4 for neutron absorber material 417, reservoir 421, and/or connector tube 423.

Continuing discussing FIG. 4, in some embodiments, gravity fed diecasting system 400 and/or gravity fed components 405 may additionally comprise neutron absorber reservoir 421 and connector tube(s) 423 for neutron absorber 417 flow. In some embodiments, neutron absorber reservoir 421 may be configured to house, retain, and/or hold one or more neutron absorber(s) 417. In some embodiments, connector tube(s) 423 may be an entirely closed fluid path, such as, but not limited to, a pipe or conduit from neutron absorber reservoir 421 and to molten reservoir 407 and/or to feed port 413. In some embodiments, connector tube(s) 423 may be configured for the movement of the neutron absorber(s) 417. In this manner the neutron absorber(s) 417 may be mixed into and/or be added to liquid (molten) medium 409. In some embodiments, the molten material 409 and the neutron absorbent material(s) 417, if needed and/or if desired, may be stored and/or maintained in a liquid state (and/or in a suspension state) in reservoir 407. In other embodiments, the neutron absorber(s) 417 in fine particle or powder form (and/or in suspension form), may be stored separately in its own reservoir 421 and then introduced via a connector tube 423 into the flowing melt 409 stream during the gravity feeding process. In some embodiments, an internal volume of reservoir 421 may be fitted with means to minimize neutron absorbent material(s) 417 located within reservoir 421 from clumping, settling, sticking together and/or to promote neutron absorbent material(s) 417 to be flowable out of reservoir 421. In some embodiments, such means may comprise a stirrer, aeration (with air or another predetermined gas like nitrogen), static charge dissipator, and/or the like. In some embodiments, connector tube(s) 423 may operatively link reservoir 421 to: reservoir 407, to port 411, and/or to port 413. See e.g., FIG. 4 for neutron absorber material 417, reservoir 421, and/or connector tube 423.

Continuing discussing FIG. 4, in some embodiments, gravity diecasting system 400, gravity fed components 405, and/or die (mold) 403 may comprise one or more (mold) release agent(s) 435. In some embodiments, release agent(s) 435 may line (coat) interior surfaces of die (mold) 403—prior to inserting a given SNF assembly (or portion thereof) therein and prior to gravity feeding of liquid (molten) medium 409 into closed die (mold) 403. In some embodiments, release agent(s) 435 may be configured to promote release of a poured/molded (and cooled) ingot 500 (casting 500) from a now open die (mold) 403. In some embodiments, the internal walls (interior surfaces) of die (mold) 403 may be initially sprayed (coated) with release agent(s) 435. In some embodiments, release agent(s) 435 may be well known in the industry; and may allow the finished molded product (e.g., ingot 500) to be released from the die-cast die (mold) 403 after the gravity feeding and after at least some cooling (such that ingot 500 is at least in a solid state). In some embodiments, release agent(s) 435 may be at least substantially (mostly) an oil, such as but not limited to, a vegetable oil. At least one of a currently commercially available mold release agent may be selected for release agent(s) 435 and its teachings, specifications, qualities, and parameters may be incorporated by reference.

Continuing discussing FIG. 4, in some embodiments, item 437 may be a connector tube for the exhaust of an inert gas, wherein the inert gas may be used in the initial stage of the loading process of the die (mold) 403. In some embodiments, item 439 may be a gas reservoir to hold the inert gas which may be purged from the die (mold) 403 during gravity feeding operations. Inert gases may be used in gravity die-casting operations to minimize oxidation and improve the casting quality. At least one primary purpose of using inert gases may be to create a protective atmosphere within the die (mold) 403 during the gravity fed die casting process. Typically, an inert gas such as, but not limited to, nitrogen and/or argon is introduced into the die (mold) 403 volume 433 prior to the gravity feeding of molten material(s) 409. In some embodiments, this inert gas may help in several ways, such as, but not limited to: (1) oxidation prevention (mitigation [minimization]); (2); heat removal; (3) porosity reduction; (4) surface finish enhancement; portions thereof; combinations thereof; and/or the like. With respect to oxidation prevention (mitigation [minimization]), inert gases may create (form) a barrier between the molten metal 409 and the surrounding air, minimizing or preventing oxidation of the metal 409. Oxidation can degrade the quality of the casting 500 and affect its mechanical properties. With respect to heat removal, inert gases aid in the quicker cooling and re-solidification of the molten metal 409, reducing cycle times and improving productivity. The inert gas helps in extracting heat from the casting 500, promoting re-solidification and maintaining dimensional accuracy. Use of the inert gas into die (mold) 403 may be done before and after the gravity feeding process (operation). With respect to porosity reduction, the use of inert gases can help reduce the formation of gas porosity within the castings 500. By displacing air and/or other gases from the die (mold) cavity 403, inert gases minimize the likelihood of gas entrapment in the molten metal 409, resulting in improved structural integrity of the resulting ingots 500. With respect to surface finish enhancement, inert gases may help improve the surface finish of the casting 500 by reducing the formation of oxide films and promoting a cleaner mold surface contact. A specific choice of inert gas and its application may vary depending on particulars of the given gravity fed die casting process, the type of metal(s) (alloy(s)) being cast, and other well know factors in the relevant art of metal/alloy diecasting. However, the general objective is to create a controlled environment within the die (mold) 403 to enhance the casting 500 quality and to reduce defects.

However, in some embodiments, some or all of the beneficial features of the use of inert gases in the die (mold) 403, may not be necessary in various applications of embodiments taught in this patent application since the end product, i.e., ingots 500, may not be consumer nor industrial items of specific required look, feel, and/or quality, but rather items that are destined for deep underground burial encapsulated in a deep horizontal wellbore (and/or human-made cavern). That is, some embodiments, of gravity fed diecasting system 400, gravity fed components 405, and/or of methods utilizing gravity fed diecasting system 400 and/or gravity fed components 405 may not use such inert gases.

Continuing discussing FIG. 4, in some embodiments, gravity diecasting system 400, gravity fed components 405, and/or die (mold) 403 may comprise an outlet port 437; and optionally an outlet reservoir 439. In some embodiments, outlet port 437 may be configured to bleed off excess gas and/or liquid (molten) medium 409 from closed die (mold) 403. In some embodiments, outlet port 437 may be pressure activated and/or high liquid level activated. In some embodiments, outlet port 437 may be operatively connected to die (mold) 403 and/or to volume 433. In some embodiments, outlet port 437 may be an enclosed fluid path, such as, but not limited to, a pipe or conduit that is configured for the movement of liquid (molten) medium 409 (and/or gases). In some embodiments, outlet port 437 may also be operatively connected to outlet reservoir 439. In some embodiments, outlet reservoir 439 may be configured to receive and hold excess liquid (molten) medium 409.

Continuing discussing FIG. 4, in some embodiments, controller 431 may be configured to operate, control, manage, monitor, open, close, start, stop, run, speed up, slow down, pause, heating, cooling, and/or the like at least one of: die (mold) 403, gravity fed components 405, melt furnace/reservoir 407, flow port 411, feed port 413, neutron absorber reservoir 421, port for neutron absorber 423, gas cylinder(s) 425, gas line 426, vent 443, a valve, a gate, a control valve, a solenoid valve, hydraulics, pressure regulator, ejection pin(s), material handler, a sensor, a thermocouple, a thermometer, a pressure indicator, portions thereof, combinations thereof, and/or the like. In some embodiments, controller 431 may be operatively connected to at least one of: gravity fed diecasting system for producing ingots with SNF assemblies therein 400, die (mold) 403, gravity fed components 405, melt furnace/reservoir 407, flow port 411, feed port 413, neutron absorber reservoir 421, port for neutron absorber 423, gas cylinder(s) 425, gas line 426, vent 443, a valve, a gate, a control valve, a solenoid valve, hydraulics, pressure regulator, ejection pin(s), material handler, a sensor, a thermocouple, a thermometer, a pressure indicator, portions thereof, combinations thereof, and/or the like. In some embodiments, any such hydraulics or the like may be opening and/or closing die (mold) 403 and/or for removing ingot 500 from die (mold) 403; but, not for feeding molten materials into die (mold) 403. In some embodiments, the operative connection (between controller 431 and an element being controlled) may be wired and/or wireless. In some embodiments, established controller 431 may comprise at least one of: a computer, computer memory, computer storage, a screen and/or a display, a PLC (programmable logic controller), a sensor, input/output (I/O) means, an antenna, a receiver, a transmitter, a radio, a monitor, a meter, a gauge, a level sensor, an optical sensor, a PIR sensor, a motion sensor, a pressure sensor, an acoustic sensor, an accelerometer, a button, a switch, a membrane switch, a dial, a slide, a lever, non-transitorily stored control software, portions thereof, combinations thereof, and/or the like.

Continuing discussing FIG. 4, in some embodiments, gravity fed diecasting system 400 and/or die (mold) 403 may comprise support(s) 441. In some embodiments, the die cast mold 403 may be supported by support(s) 441. In some embodiments, support(s) 441 may be configured to physically support die (mold) 403, including when die (mold) 403 may house a given SNF assembly 106 (or portion thereof) or when die (mold) 403 may house a given ingot 500 (casting 500). In some embodiments, support(s) 441 may be operatively connected to an exterior of die (mold) 403. In some embodiments, support(s) 441 may be attached to an exterior of die (mold) 403.

In some embodiments, gravity fed diecast molding system 400 may additionally comprise radiation shielding components, parts, and/or structures.

FIG. 5A is a lengthwise cross-sectional diagram through a given ingot 500 (casting 500) that was output from gravity diecasting system 400 (see also, FIG. 8 of method 800 that may comprise steps of making a given ingot 500). Exterior surface 501 is an exterior surface of ingot 500. In some embodiments, FIG. 5A shows at least substantially (mostly) all of volume 433 within an exterior surface 501 of ingot 500 is of the resolidified metal(s) and/or alloy(s) 409, aside from where SNF assembly 106 (or portion thereof) occupies that volume 433. Also note, SNF assembly 106 (or portion thereof) in FIG. 5A (and in FIG. 5B) is now shown with a reference numeral of “506” instead of 106 to emphasize that once ingot 500 is formed, that SNF assembly 106 (or portion thereof) has been modified such that its prior (formerly) free void spaces 301 are now no longer free void spaces 301 but are now instead occupied by the resolidified metal(s) and/or alloy(s) 409 (which may or may not include neutron absorber(s) 417). This FIG. 5A cross-section shows the ingot 500 and the relationship between the resolidified alloy (metal) 409, which surrounds the modified SNF assembly 506 (or portion thereof) and forms a solid metal protective “cocoon” around that modified SNF assembly 506 (or portion thereof). Recall, in some embodiments, this resolidified metal(s) and/or alloy(s) 409 of a given ingot 500, may also contain (comprise) dispersed neutron absorber(s) 417 within the resolidified metal(s) and/or alloy(s) 409. Note, FIG. 5A includes sectional line 5B-5B, whose cross-section is shown in FIG. 5B.

FIG. 5B is a transverse width cross-sectional diagram taken through sectional line 5B-5B of FIG. 5A. FIG. 5B is a transverse width cross-sectional diagram taken through a middle portion (with respect to a length) of a given ingot 500 (casting 500) that was output from diecasting gravity feed molding system 400, gravity fed components 405, die (mold) 403, and/or from method 800 (see FIG. 8 for method 800). In some embodiments, FIG. 5B shows at least substantially (mostly) all of volume 433 within an exterior surface 501 of ingot 500 is of the resolidified metal(s) and/or alloy(s) 409, aside from where SNF assembly 106 (or portion thereof) occupies that volume 433. Also note, SNF assembly 106 (or portion thereof) in FIG. 5B (and in FIG. 5A) is now shown with a reference numeral of “506” instead of 106 to emphasize that once ingot 500 is formed, that SNF assembly 106 (or portion thereof) has been modified such that is prior (formerly) free void spaces 301 are now no longer free void spaces 301 but are now instead occupied by the resolidified metal(s) and/or alloy(s) 409 (which may or may not include neutron absorber(s) 417). This FIG. 5B cross-section shows the ingot 500 and the relationship between the resolidified alloy (metal) 409, which surrounds the modified SNF assembly 506 (or portion thereof) and forms a solid metal protective “cocoon” around that modified SNF assembly 506 (or portion thereof). Recall, in some embodiments, this resolidified metal(s) and/or alloy(s) 409 of a given ingot 500, may also contain (comprise) dispersed neutron absorber(s) 417 within the resolidified metal(s) and/or alloy(s) 409. Also shown in FIG. 5B, may be a minimum thickness 503 of ingot 500 from exterior surface 501 until an exterior structure of modified SNF assembly 506 (or portion thereof) located within that given ingot 500 (casting 500). In some embodiments, thickness 503 of ingot 500 may be at least one (1.5) inches, plus or minus one-half (0.5) inch.

FIG. 5C is a partial perspective (isometric) view of a given ingot 500 (casting 500) that was output from diecasting gravity injection molding system 400, gravity fed components 405, die (mold) 403, and/or from method 800 (see FIG. 8 for method 800). Recall, ingot 500 may internally hold at least one modified SNF assembly 506 (or portion thereof) (see e.g., FIG. 4, FIG. 5A, and FIG. 5B). FIG. 5C shows portions of exterior surface 501 of ingot 500. FIG. 5C shows exterior surface 501 may have a smooth and/or polished finish in some embodiments; however, exterior surface 501 may have other surface geometry depending upon the interior surface geometry of its generating die (mold) 403. In some embodiments, ingots 500 may be handled easily by robotic handler 427. In some embodiments, ingots 500 may be handled easily by existing material handling machinery developed and used for handling and transporting heavy solid cylindrical goods in industry today (such as, but not limited to, mobile traveling cranes, gantry cranes, and/or the like). In some embodiments, robotic handler 427, and/or preexisting material handling machinery may be configured to handle loads of 1,000 to 20,000 pounds. Material handling operations of ingots 500 may not require any additional experimentation or development, aside from including radiation shielding where desired and/or needed to protect personnel and/or equipment/machinery from radiation.

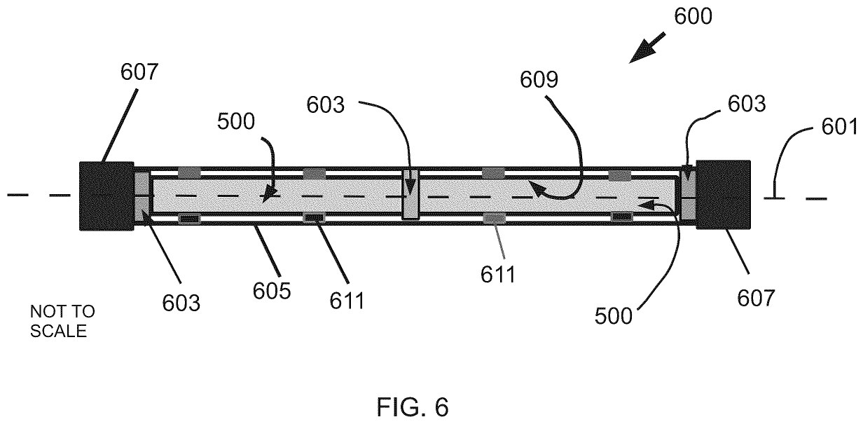

FIG. 6 is a lengthwise cross-sectional diagram through a given waste disposal capsule 600 (waste-disposal-capsule 600). In some embodiments, waste disposal capsule 600 may be comprised and/or configured to house at least one (1) ingot 500 (casting 500). In some embodiments, waste disposal capsule 600 may be comprised and/or configured to house at least two (2) ingots 500 (castings 500). In some embodiments, waste disposal capsule 600 may be comprised and/or configured to house three (3) or fewer ingots 500 (castings 500). In some embodiments, when two (2) or more ingots 500 (castings 500) may reside within a given waste disposal capsule 600, those ingots 500 (castings 500) may be arranged end-to-end within that given waste disposal capsule 600, such that the ingots 500 and the waste disposal capsule 600 are (at least mostly [substantially]) concentric about a common central axis 601 and/or such that the lengths of the ingots 500 and the waste disposal capsule 600 are all at least substantially (mostly) parallel with each other. In some embodiments, when two (2) or more ingots 500 may reside within a given waste disposal capsule 600, nearest terminal ends of those ingots 500 may be physically separated from each other by at least one plate (divider [separator]) 603. In some embodiments, between each sequential installed ingot 500 may be placed (disposed) at least one (1) neutron absorber plate 603. In some embodiments, plate 603 may be at least a substantially (mostly) cylindrical disc (disk) (or wafer). In some embodiments, plate 603 may be configured for neutron absorption. In some embodiments, waste disposal capsule 600 may be formed from a hollow metal cylinder (tube and/or pipe) 605. In some embodiments, waste disposal capsule 600 may be formed from a hollow thick-walled steel cylinder (tube and/or pipe) 605. In some embodiments, an inside diameter of metal tube 605 may be larger than an outside diameter of ingot 500. In some embodiments, metal tube 605 may initially have open opposing terminal ends, which may provide access to an interior of metal tube 605 for loading of ingot(s) 500 therein. In some embodiments, the two opposing open terminal ends of a given metal tube 605 may be closed (sealed) by attaching one coupling 607 to each such open terminal end of the given metal tube 605. Thus, a given metal tube 605 that has both of its two opposing open terminal ends closed, may then have two opposing couplings 607. A variety of well-known and currently available mechanical means may be used to attach a coupling 607 to metal tube 605. In some embodiments, a given completed waste disposal capsule 600 may comprise one (1) metal tube 605 and two (2) opposing couplings 607. In some embodiments, a given coupling 607 may be attached to a given terminal end of a given metal tube 605 by mechanical means (such as, but not limited to, a threaded connection, crimping, riveting, friction fit, and/or the like) and/or by welding.

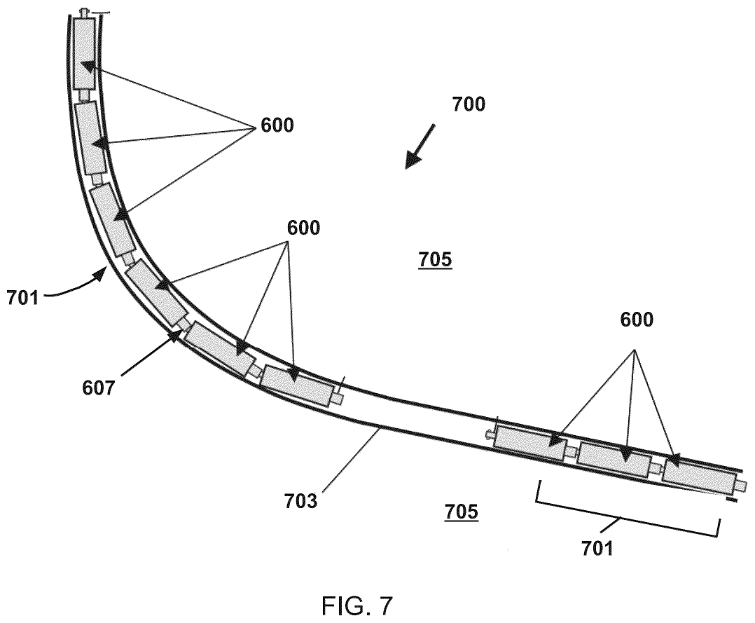

Continuing discussing FIG. 6, in some embodiments, each coupling 607 may contain exterior geometry and/or structure that is configured to permit two different waste disposal capsules 600 to be (removably) connected to each other, in an end-to-end fashion such as is shown in FIG. 7, to yield a “string” of two or more (removably) connected waste disposal capsules 600. Note such exterior geometry and/or structure that permits such strings is well known in the oil field development industries, wherein such technology is incorporated by reference as if fully set forth herein. In some embodiments, two or more waste disposal capsules 600 may be connected linearly by their abutting couplings 607 which may allow a string of as many as twenty (20) filled waste disposal capsules 600 to be connected together (in the end-to-end fashion) to allow the waste disposal capsules 600 to be sequestered rapidly as a single unit by a drill rig capable of several hundred thousand pounds of lift capacity (such as, an oil field drill rig).

Continuing discussing FIG. 6, in some embodiments, disposed between a given attached coupling 607 and a terminal end of a closest installed ingot 500 may be at least one installed plate 603. In some embodiments, a given completed waste disposal capsule 600, with only one (1) installed ingot 500 may have at least two opposing installed plates 603 installed, with one such plate 603 installed inside of each coupling 607. In some embodiments, a given completed waste disposal capsule 600, with only two (2) installed ingots 500 may have at least three (3) installed plates 603 installed, with one such plate 603 installed inside of each coupling 607 and the third plate 603 being installed between the two installed ingots 500. See e.g., FIG. 6.

Continuing discussing FIG. 6, in some embodiments, installed around each installed ingot 500 may be a sleeve 609. In some embodiments, sleeve 609 may be configured for neutron absorption. In some embodiments, sleeve 609 may be at least a substantially (mostly) a hollow cylindrical structural member. In some embodiments, sleeve 609 may have a diameter that is larger than an outside diameter of ingot 500 but less than an inside diameter of metal tube 605. In some embodiments, lengths of metal tube 605, sleeve 609, and ingots 500 of a given waste disposal capsule 600 may be concentric with each other about a common central axis 601 and/or such that these lengths may all be at least substantially (mostly) parallel with each other, with respect to an assembled and filled waste disposal capsule 600. In some embodiments, a given waste disposal capsule 600 may comprise at least one (1) sleeve 609 that may be longer than the combined lengths of installed ingots 500 and their separating plates 603 within that given waste disposal capsule 600. In some embodiments, a given waste disposal capsule 600 may comprise at least one (1) sleeve 609 per each installed ingot 500.

In some embodiments, these neutron absorber systems of plates 603 and/or of sleeve 609 may be made at least partially of borated steel which has been demonstrated in industry to safely moderate radiation and/or neutron emission effects.

Continuing discussing FIG. 6, in some embodiments, installed around the exterior and the lengths of each installed ingot 500 (and/or around the exterior of the installed sleeve(s) 609) may be at least one support (standoff) 611. In some embodiments, installed supports (standoffs) 611 may prevent exterior surfaces along the length of installed ingot(s) 500 (and/or of installed sleeve(s) 609) from physically touching interior surfaces of metal tube 605. In some embodiments, installed supports (standoffs) 611 may facilitate maintaining the concentric (and/or centralized) relationship around the common central axis 601 of a given waste disposal capsule 600 with respect to the lengths of metal tube 605, sleeve 609, and ingots 500 of that given waste disposal capsule 600.

Continuing discussing FIG. 6, in some embodiments, waste disposal capsule 600 may comprise at least one of: plate 603, metal tube 605, coupling 607, sleeve 609, support (standoff) 611, a portion thereof, combinations thereof, and/or the like. In some embodiments, waste disposal capsule 600 may comprise at least one of: plate 603, metal tube 605, coupling 607, sleeve 609, support (standoff) 611, ingot 500, a portion thereof, combinations thereof, and/or the like. In some embodiments, waste disposal capsule 600 may comprise: at least two plates 603, at least one metal tube 605, at least two couplings 607, at least one sleeve 609, a plurality of supports (standoffs) 611, a portion thereof, combinations thereof, and/or the like. In some embodiments, waste disposal capsule 600 may comprise: at least two plates 603, at least one metal tube 605, at least two couplings 607, at least one sleeve 609, a plurality of supports (standoffs) 611, at least one ingot 500, a portion thereof, combinations thereof, and/or the like.

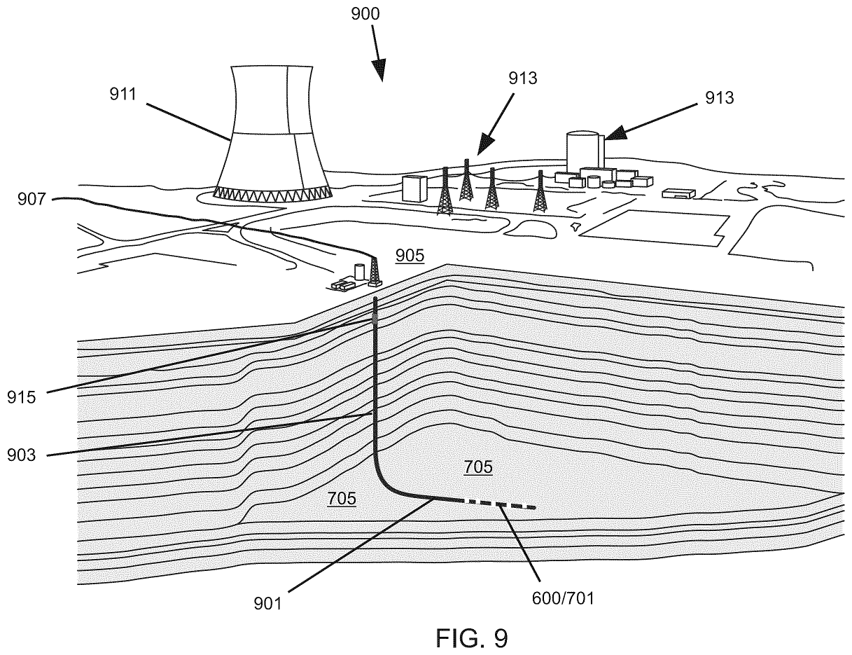

FIG. 7 shows a cross-section through a section (region and/or portion) of a system 700 for disposal of waste within deeply located wellbore(s) 703. FIG. 7 shows an illustration of at least two (end-to-end) adjacent physically linked waste disposal capsules 600, which in such a configuration may form a string 701 of waste capsules 600, located inside of a given wellbore 703. Note, in some embodiments, the system 700 section (region and/or portion) shown in FIG. 7 may be a section (region and/or portion) of waste disposal repository system 900 shown more fully in FIG. 9. Continuing discussing FIG. 7, in some embodiments, at least a portion of that wellbore 703 may be located within at least one deeply located geologic formation (rock) 705. In some embodiments, any two waste capsules 600 that may be adjacently aligned end-to-end (e.g., with one terminal end of one waste capsule 600 next to one terminal end of a different waste capsule 600) may be mechanically joined (linked) together via mechanical interactions of their two closest capsule connector devices 607 (couplings 607) from each of the two different waste capsules 600. Thus, two or more waste capsules 600 may be mechanically linked together to form a string 701 of waste capsules 600. In some embodiments, such a string 701 of waste capsules 600 may be loaded, landed, inserted, and/or emplaced within a given wellbore 703, wherein that given wellbore 703 may extend into at least one deeply located geological formation (rock) 705. In some embodiments, via mechanically interacting capsule connector devices 607 (couplings 607), at least two non-linked, but end-to-end adjacent waste capsules 600, may be (removably) coupled (linked and/or attached) together (e.g., to form a given string 701 of waste capsules 600 or to become part of an existing string 701 of waste capsules 600). In some embodiments, at least two non-linked, but end-to-end adjacent waste capsules 600, may be coupled (linked and/or attached) together, within or outside of a given wellbore 703, to form a given string 701 of waste capsules 600 or to become part of an existing string 701 of waste capsules 600. In some embodiments, at least two linked waste capsules 600 within a given string 701 of waste capsules 600, may be decoupled. In some embodiments, at least two linked waste capsules 600 within a given string 701 of waste capsules 600, may be decoupled, within or outside of a given wellbore 703.

Continuing discussing FIG. 7, in some embodiments, wellbore 703 may be lined with casing(s) and/or section(s) of pipe, such as, but not limited to, steel piping, with or without concrete and/or cement located exteriorly to the piping and inside of the native rock (e.g., formation 705). In some embodiments, wellbore 703 may comprise at least substantially (mostly) vertical sections, horizontal sections (lateral sections), transitional sections (that join a vertical section to a horizontal [lateral] section), a portion thereof, combinations thereof, and/or the like. In some embodiments, the at least substantially (mostly) vertical sections, horizontal sections (lateral sections), transitional sections, a portion thereof, combinations thereof, and/or the like, of a given wellbore 703 may be operatively (and physically) connected to each other. In some embodiments, the at least substantially (mostly) vertical sections, horizontal sections (lateral sections), transitional sections, a portion thereof, combinations thereof, and/or the like, of a given wellbore 703 may be integral to each other. See also, FIG. 9.

In some embodiments, handling waste capsule(s) 600 and/or string(s) 701 of waste capsule(s) 600, within wellbore(s) 703, may be accomplished using drill rigs, downhole tools, tooling, machines, devices, apparatus, systems, methods, processes, and/or techniques of the oil field industry that are in use today and well understood. Such preexisting downhole tools, tooling, machines, devices, apparatus, systems, methods, processes, and/or techniques of the oil field industry are incorporated by reference herein as if fully set forth herein.

Also note, the waste capsules 600 in FIG. 7 need not be (removably) connected to each other for forming string(s) 701. In some embodiments, waste capsules 600 within a given wellbore 703 need not be (removably) connected to each other in the string(s) 701 configuration.

FIG. 8 is a flow diagram showing at least some steps in a method 800. In some embodiments, method 800 may be a method for one or more of the following: processing SNF assemblies (or portions thereof); processing SNF assemblies (or portions thereof) for long-term disposal; processing SNF assemblies (or portions thereof) to be entirely encapsulated within ingot(s) 500 (casting(s) 500); inserting ingot(s) 500 (with SNF assemblies [or portions thereof]) into waste capsule(s) 600; inserting loaded waste capsule(s) 600 into wellbore(s) system(s) 700 and/or 900; building wellbore(s) system(s) 700 and/or 900; a portion thereof; combinations thereof; and/or like. In some embodiments, method 800 may comprise at least one of the following steps: step 801, step 803, step 805, step 807, step 809, step 811, step 813, step 814, step 815, step 816, step 817, step 818, step 819, step 821, step 823, step 825, step 827, step 829, step 831, step 833, step 835, step 837, a portion thereof, combinations thereof, and/or the like. In some embodiments, at least one of these steps of method 800 may be optional, skipped, omitted, executed out of numeral order with respect to a step's reference numeral, a portion thereof, combinations thereof, and/or the like.

Continuing discussing FIG. 8, in some embodiments, step 801 may be a step of selecting, collecting, and/or gathering SNF assemblies (or portions thereof) for use in method 800. In some embodiments, the SNF assemblies or portions thereof that may be processed and/or acted upon by method 800 may be SNF assembly 106, group (bundle) of SNF assemblies 105, SNF assembly 101, SNF assembly 103, modified SNF assembly 506, SNF assembly 205, base 307, spent nuclear fuel assembly, fuel rod, fuel pellet, control rod, a portion thereof, combinations thereof, and/or the like. In some embodiments, these SNF assemblies may be found in temporary storage in (surface) cooling ponds and/or in surface (or near surface) storage in dry cask containers, which may be shown as structures 913 in FIG. 9. In some embodiments, step 801 may be a step of locating, identifying, and/or selecting the SNF assemblies (or portions thereof) from multiple power plant 911 sites (see FIG. 9 for nuclear power plant 911), cooling pond's locations, dry cask (intended temporary storage) containers locations, portions thereof, combinations thereof, and/or the like. In some embodiments, any such located and/or identified SNF assemblies (or portions thereof) may be selected for use in method 800. In some embodiments, execution of step 801 may be done onsite at a given nuclear power plant 911 (with cooling ponds) in a specialized area of the “site” (grounds) of that given nuclear power plant 911. In some embodiments, “site” may be defined in U.S. nonprovisional patent application Ser. No. 18/108,001, filed on Feb. 9, 2023, by the same inventor as the present patent application; wherein the disclosure of U.S. nonprovisional patent application Ser. No. 18/108,001 is incorporated herein by reference in its entirety as if fully set forth herein. In some embodiments, the collected SNF assemblies (or portions thereof) may be transported offsite from the temporary storage locations (e.g., cooling ponds and/or dry cask containers) to remote and/or different site(s) for further operations of method 800 (such as, but not limited to, sites of system 700 and/or 900). In some embodiments, this type of multi-plant/multi-location operation, step 801 may be a means of accumulating and commingling various quantities of the SNF assemblies (or portions thereof) for processing at one or more centrally located site(s), according to further steps of method 800. In some embodiments, this approach may increase efficiencies and lower operational costs, and personnel needs for disposal of SNF assemblies (or portions thereof). In some embodiments, at least partial execution of step 801 (e.g., collection of at least one SNF assembly [or portion thereof]) may progress method 800 to step 803.

Continuing discussing FIG. 8, in some embodiments, step 803 may be a step of determining, calculating, measuring, finding, and/or the like, the free (void) volume 301 of a given SNF assembly (or portion thereof). This computation and/or determination may be important in order to accurately determine a volume of melted metal(s), alloy(s), and/or (optional) neutron absorbent that may be used during a molten diecasting gravity fed process to both entirely fill the void space 301 and that will entirely cover over an exterior of the given SNF assembly (or portion thereof) by a minimum thickness (that minimizes criticality). This internal intricate void space 301, of a typical SNF assembly (or portion thereof), may be easily and readily determined by a number of well-known techniques, all of which are incorporated by reference. For example, and without limiting the scope of the present invention, this internal intricate void space 301, of a typical SNF assembly (or portion thereof), may be easily and readily determined from digital 3D modeling software used to model a given SNF assembly (or portion thereof). For example, and without limiting the scope of the present invention, this internal intricate void space 301, of a typical SNF assembly (or portion thereof), may be easily computed empirically by a liquid displacement process on a given finished SNF assembly (or portion thereof). In some embodiments, execution of step 803 may progress method 800 to step 805, step 807, and/or step 813.

Continuing discussing FIG. 8, in some embodiments, step 805 may be a step of determining and/or selecting the metal(s) and/or the alloy(s) that will be used in the gravity fed diecast molding process to produce a given ingot 500 (casting 500) with a SNF assembly or portion thereof located within that ingot 500. In some embodiments, this metal(s) and/or the alloy(s) may be at least one copper alloy. In some embodiments, this metal(s) and/or the alloy(s) may be at least one copper and aluminum alloy (Cu—Al alloy(s)), copper and nickel alloy (Cu—Ni alloy(s)), a portion thereof, combinations thereof, and/or the like. Copper-aluminum alloys offer high strength and excellent corrosion resistance. Copper-aluminum alloys are suitable for the types of operations discussed herein in this patent application for forming the ingots 500 because of their comparable light weight and corrosion-resistant properties while still being sufficiently strong (e.g., as compared to other alloys, such as steel). In addition, copper-nickel alloys are also suitable and usable because of their outstanding corrosion resistance in the deep geological disposal formation 705 environments and geological conditions. The composition of this determined and/or selected metal(s) and/or the alloy(s) may be also be accomplished empirically and also by optimal use of artificial intelligence AI models based on existing alloy composition data or other synthetic data to provide optimal temperature response during the gravity diecasting pouring operations, fluidity for injection, and/or overall cost lowering of operations. Such parameters and/or details are well-known in the industrial diecasting industry and may be AI modeled to provide sufficient accuracy and repeatability of operations for method 800 and/or for step 805. In some embodiments, execution of step 805 may progress method 800 to step 807 and/or to step 811.

Continuing discussing FIG. 8, in some embodiments, step 807 may be a step of a volume determination of the selected and/or determined metal(s) and/or alloy(s) from step 805 that may be used to form the given ingot 500 (casting 500). In some embodiments, as inputs, this step 807 may utilize the exterior dimensions of the given SNF assembly (or portion thereof), its determined free void space 301; a volume of die (mold) 403; a density of the selected and/or determined metal(s) and/or alloy(s) from step 805 (e.g., when molten); portions thereof; combinations thereof; and/or the like. In some embodiments, this determination of melt volume of step 807 may be based, at least in part, on adding the free volume 301 determined in step 803 above to the additional volume outside (exterior) of the given SNF assembly (or portion thereof) body and the inner walls (interior surfaces) of the die (mold) 403. In some embodiments, a maximum or upper limit for this volume of step 807 may be the volume of die (mold) 403. In some embodiments, execution of step 807 may progress method 800 to step 809, step 805, and/or to step 811.

Continuing discussing FIG. 8, in some embodiments, step 809 may be a step of performing a fissile criticality analysis (FCA) with respect to at least one of: SNF assembly (or portion thereof) size and/or type (that is intended for emplacement within a given ingot 500); die (mold) 403 design; ingot 500 design; loaded waste capsule 600 design; wellbore(s) system(s) 700 and/or 900 design; a portion thereof; combinations thereof; and/or the like; wherein design may be with respect to size (dimensions), volume, shape, geometry, materials of construction, and/or the like. In some embodiments, as a safety precaution, a fissile criticality analysis (FCA) may be desired, required, and/or implemented, prior to making (building and/or constructing) a given die (mold) 403, ingot 500, loaded waste capsule 600, wellbore(s) system(s) 700 and/or 900, a portion thereof, combinations thereof, and/or the like; with respect to the SNF assemblies (or portions thereof) sizes and/or types to be used in method 800, ingots 500, loaded waste capsules 600, wellbore(s) system(s) 700 and/or 900, a portion thereof, combinations thereof, and/or the like. In some embodiments, a fissile criticality analysis (FCA) may be performed on at least one of: the contemplated SNF assembly (or portion thereof) size and/or type; die (mold) 403 design; ingot 500 design; loaded waste capsule 600 design; wellbore(s) system(s) 700 and/or 900 design; a portion thereof; combinations thereof; and/or the like; and/or on the equipment that may handle the ingots 500 and/or the waste capsules 600 and/or that may handle the nuclear (radioactive) waste, to determine metrics such as, but not limited to: waste composition; waste type; waste density; waste weight; waste volume; waste size (dimensions); waste shape (geometry); ingot 500 composition; (loaded) waste capsule 600 composition; ingot 500 density; (loaded) waste capsule 600 density; ingot 500 weight; (loaded) waste capsule 600 weight; ingot 500 volume; (loaded) waste capsule 600 volume; ingot 500 size (dimensions); (loaded) waste capsule 600 size (dimensions); ingot 500 shape (geometry); (loaded) waste capsule 600 shape (geometry); ingot 500 materials of construction; (loaded) waste capsule 600 materials of construction; ingot 500 thickness; (loaded) waste capsule 600 thickness; quantity of ingots 500 per a given waste capsule 600; plates 603 materials of construction; plates 603 thickness; plates 603 size (dimension); plates 603 shape (geometry); plates 603 quantity per a given waste capsule 600; plates 603 placement locations within a given waste capsule 600; sheaths 609 materials of construction; sheaths 609 thickness; sheaths 609 size (dimension); sheaths 609 shape (geometry); sheaths 609 quantity per a given waste capsule 600; sheaths 609 placement location within a given waste capsule 600; formation (rock) properties of the formation (rock) 705 that immediately surrounds a given or planned deeply located geological repository 700; and/or geometry of the disposal system 700 and/or 900 and its contents such that the nuclear (radioactive) waste material always remains subcritical. In some embodiments, this FCA analysis may provide (yield) upper limits on the weight per unit of material, typically called “gram-limits,” which may be the maximum quantity of fissile material in a given ingot 500 and/or in a given waste capsule 600. In some embodiments, the required gram limits may be used in all or some of the subsequent waste disposal processes. In addition, the criticality analysis (FCA) may utilize factors such as, physical volumes of waste, material burnup times, time out of the reactor, and other well-known safety metrics to define the final configuration of the waste package (waste capsule). Execution of FCA is well known in the industry and such FCA industry teachings are incorporated by reference as if fully set forth herein. Fissile Critical Analysis (FCA) may be performed by various presently available computer programs, codes, algorithms, models, and/or the like. Some of these may be as follows: SCALE (Standardized Computer Analysis for Licensing Evaluation); MCNP (Monte Carlo N-Particle Transport Code); MONK (Monte Carlo N-Particle Kinetics Code); AMPX (Advanced Multi-group Cross-section Processor); and PARTISN. These are available to researchers and many federal and private agencies alike. In some embodiments, execution of step 809 may progress method 800 to step 807, step 811, and/or step 813.

In some embodiments, a fission criticality analysis (FCA) on the nuclear waste form may be performed to assess the potential for a dangerous self-sustaining nuclear chain reaction within the waste package (e.g., whether that may be a given ingot 500, a given waste capsule 600, and/or a strong 701). In some embodiments, this FCA analysis may be crucially important to ensure the safe handling, transportation, and/or storage of nuclear waste. Past criticality incidents have occurred in the U.S., Japan, and Russia because of inadequate criticality analysis.

In some embodiments, general steps involved in conducting a criticality analysis may be: define the system boundaries; identify the fissile materials; determine the neutron multiplication factors; assess neutron moderation; consider neutron absorption; perform criticality calculations, using computational tools and established mathematical models. And finally, in some embodiments, meet all applicable and/or relevant regulatory requirements.

Note, prior art neutron absorbing utilization has involved using neutron absorbing inserts within steel capsules that contain SNF assemblies. Neutron-absorbing steel inserts or rods were placed strategically around the SNF assemblies, but never within the internal structures of the SNF assemblies, such as, never within the internal void spaces 301 of the SNF assemblies. These neutron absorbing inserts were usually made of boron carbide, which has a high neutron absorption cross-section, making it an effective neutron absorber. In the present patent application, in some embodiments, because of the high temperature of the molten gravity fed process using molten composition 409, the molten composition 409 when it contains neutron absorbent materials, places and forces these neutron absorbent materials into the internal matrix structure internal void spaces 301 of the SNF assembly (or portion thereof) which the prior art never contemplated nor did.

Continuing discussing FIG. 8, in some embodiments, step 809 may also be a step of determining an important operating parameter which may be the cooling time where ingot 500 may be removed from the die (mold) 403 after the injection process has completed (see also step 827 for when method 800 executes this cooling). In some embodiments, this cooling time for a diecasting molten gravity fed process may be a minimum time required before a given produced ingot 500 may be ready to be removed from its die (mold) 403. Cooling time may vary depending on several factors, such as, but not limited: gravity fed operating temperatures (any pressure above local atmospheric pressure may be from the high temperatures and not from an external high pressure means); die (mold) 403 size and complexity; SNF assembly (or portion thereof) size and complexity; the type and the volume of molten (melted) materials being used (e.g., the metal(s) and/or the alloy(s)); ingot 500 size and complexity; the cooling method(s) being employed; the cooling medium(s) being employed; a portion thereof; combinations thereof; and/or the like. During the gravity die-casting process illustrated in FIG. 4, molten material 409 may be gravity introduced (fed and/or poured) into the die (mold) 403 under gravity flow and at high enough temperatures to keep 409 liquid (molten and/or melted) during the active gravity feeding process. After the gravity feeding, the cooling phase begins (even when the die (mold) 403 may still be closed), during which the liquid (molten and/or melted) material(s) 409 resolidifies taking the shape of the die (mold) 403 internal surfaces to produce a solid ingot 500 (with a SNF assembly [or portion thereof] located within that ingot 500). The cooling time typically refers to the duration required for ingot 500 (casting 500) to reach a temperature where ingot 500 (the casting) may safely be ejected (removed) from die (mold) 403 without unacceptable deformation, i.e., ingot 500 may to have cooled sufficiently to be self-supporting without its shape changing. In some embodiments, the cooling time can range from a minute to several minutes, depending on several factors. In some embodiments, at least some of the factors that may influence the cooling time include (comprise): casting size and thickness; metal(s) and/or alloy(s) type(s) and/or composition(s); cooling method(s); injection operating temperatures and pressures; die (mold) 403 size and complexity; SNF assembly (or portion thereof) size and complexity; the type and the volume of molten (melted) materials being used (e.g., the metal(s) and/or the alloy(s)); ingot 500 size and complexity; the cooling method(s) being employed; the cooling medium(s) being employed; a portion thereof; combinations thereof; and/or the like. With respect to, casting size and thickness: larger and thicker castings (ingots 500) generally take longer to cool due to the increased amount of heat that needs to be dissipated (i.e., heat transfer is often proportional to the mass that needs cooling). With respect to, metal(s) and/or alloy(s) type(s) and/or composition(s): different metals and/or alloys have varying cooling rates. Some metals, such as aluminum, cool relatively quickly, while others, like steel, may require longer cooling times. With respect to, the cooling method: the cooling method used can also affect the cooling time. Cooling can be accomplished through natural radiation, conduction, and/or convection, and/or cooling may use additional cooling mechanisms such as water (or other liquids and/or fluid) and/or air (or other gas) sprays, cooling channels within the mold 403, and/or other cooling means that are well used and well understood in the industrial diecasting injection molding processes. Preexisting castings cooling methods are incorporated by reference. In some embodiments, an initial cooling time may be determined, calculated, selected, and/or approximated prior to gravity diecasting operations during the initial process of modeling the system operations, such as, in step 809 of method 800, prior to method 800 executing the cooling step 827. And then, the cooling time may change during operation as experience is gained on the behavior of the total gravity die-cast injection system. This optimization process may allow for more efficient operations as thousands of SNF assemblies are processed according to method 800. In some embodiments, execution of step 809 may progress method 800 to step 811, step 807, and/or to step 813.

Continuing discussing FIG. 8, in some embodiments, step 811 may be a step of melting the melt materials 409 that are intended to be gravity poured into the closed die (mold) 403 (with the SNF assembly or portion thereof located within that closed die 403) during step 825. In some embodiments, step 811 may be accomplished with an established melt furnace 407 and/or embodiments, the liquid (molten and/or melted) materials 409 may comprise the at least one selected and/or determined metal(s), alloy(s), and/or the neutron absorbing members (e.g., boron carbide [B₄C]), a portion thereof, combinations thereof, and/or the like. In some embodiments, execution of step 811 may progress method 800 to step 814, step 816, and/or to step 815.

Continuing discussing FIG. 8, in some embodiments, step 814 may be a step of measuring, collecting, transferring, and/or the like the volume of melt materials 409 from step 811, and making such collected volume of melt material 409 ready for gravity feeding (in step 825). In some embodiments, this collected volume of melt materials 409 of this step 814, may be stored in melt reservoir 407. In some embodiments, execution of step 814 may progress method 800 to step 817 and/or to step 816.

Continuing discussing FIG. 8, in some embodiments, step 815 may be a step of selecting and/or determining which, if any, of neutron absorbers (such as, but not limited to, boron carbide [B₄C]) are to be included into the molten materials 409 and/or into the closed and loaded die 403 during step 825. In some embodiments, the selection and/or the determination of the neutron absorbers may be determined by the FCA of step 809 and/or FCA may be carried out in step 815. In some embodiments, execution of step 815 (and/or of step 809) may also determine a desired amount of such neutron absorbers for inclusion. In some embodiments, execution of step 815 may progress method 800 to step 816.

Continuing discussing FIG. 8, in some embodiments, step 816 may be a step of measurably and/or controllably adding the selected and/or determined neutron absorber (e.g., from step 815 and/or from step 809) (e.g., from neutron absorber reservoir 421) to the molten materials 409 during the gravity feed process. In some embodiments, execution of step 816 may progress method 800 to step 823 and/or to step 825.

Continuing discussing FIG. 8, in some embodiments, step 817 may be an optional step of preheating the SNF assembly (or portion thereof) material before that given SNF assembly (or portion thereof) is loaded (inserted) into the mold 403. In some embodiments, step 817 may be accomplished with industrial heaters that are well known in the industry and that are incorporated by reference. In some embodiments, after execution of step 817 may progress method 800 to step 818. Note, if step 817 was omitted or skipped, then step 814 may progress directly to step 818 (and/or to step 816).

When molten copper is used as the injected and/or gravity fed molten fluid in a diecast operation on spent nuclear fuel (SNF) assemblies, eutectic mixtures may form between the copper melt and the zircaloy SNF tubes that hold the spent uranium material; and may lead to several operational problems. Even though the operating time of the injection and/or gravity fed process may be short, e.g., in minutes and not hours in some embodiments, there may still be a possibility of eutectic mixtures being formed between the zircaloy tubes of the SNF assembly and the selected copper melt. The eutectic point between copper and zirconium (a primary component of zircaloy) occurs at a temperature around 830 degrees Celsius (° C.), which is lower than the individual melting points of copper (1,085° C.) and zirconium (1,855° C.), respectively.

During the diecast process, the interaction at the interfaces between the molten copper and zircaloy tubes can cause eutectic reactions, resulting in the formation of a eutectic mixture with a lowered melting point. Furthermore, the formation of eutectic mixtures may result in undesirable chemical interactions, such as corrosion and alloying, further degrading the material properties of both the copper and zircaloy. These issues may require stringent control of process temperatures, careful selection of materials, and possibly the application of diffusion barrier coatings to prevent direct contact between the copper melt and zircaloy tubes, ensuring the stability and safety of the diecast operation in encapsulating spent nuclear fuel (SNF) assemblies.

In this patent application, potential problems arising from eutectic mixtures formed between the copper melt fluid and zircaloy tubes in die cast operations on spent nuclear fuel (SNF) assemblies may be resolved through several practical approaches.

To at least partially coat, cover, and/or or protect surfaces of interior components of spent nuclear fuel (SNF) assemblies to prevent the formation of eutectics on the SNF zircaloy tubes, several methods may be utilized. These methods may involve coating, spraying, painting, dipping, a portion thereof, combinations thereof, and/or the like processes, utilizing materials that can withstand the harsh environment inside the SNF assemblies. What follows are some potential approaches coating or the like: (1) ceramic coatings; (2) metallic coatings; (3) polymer coatings; (4) oxide coatings; (5) composite coatings; (6) surface treatments; (7) chemical coatings; a portion thereof; combinations thereof; and/or the like.

Ceramic coatings provide high-temperature resistance and excellent chemical stability. These coatings can be applied through: thermal spraying, chemical vapor deposition (CVD), a portion thereof, combinations thereof, and/or the like. Thermal Spraying may involve melting ceramic powders and spraying them onto the surface of the zircaloy tubes using a high-velocity gas stream. Chemical vapor deposition (CVD) may involve reacting volatile ceramic compounds with the surface of the tubes to form a thin, protective ceramic layer.

Applying a metallic coating can provide a barrier to eutectic formation and improve the oxidation resistance of zircaloy tubes. Applying a metallic coating may be done via electroplating, physical vapor deposition (PVD), a portion thereof, combinations thereof, and/or the like. Electroplating may use an electric current to deposit a layer of metal (e.g., nickel, chromium, and/or the like) onto the surface of the zircaloy tubes. Physical vapor deposition (PVD) may deposit metal from a metal vapor onto the tubes in a vacuum chamber, forming a thin and/or uniform layer of such deposited metal onto the exterior surfaces of the zircaloy SNF tubes.

High-temperature resistant polymers coatings may be applied onto the exterior surfaces of the zircaloy SNF tubes. This may be done by spray coating, by dipping, a portion thereof, combinations thereof, and/or the like. Spray coating may apply polymer-based solutions or suspensions via spraying to form a protective layer after drying and curing onto the exterior surfaces of the zircaloy SNF tubes. Dipping may (at least partially) submerge the exterior surfaces of the zircaloy SNF tubes in a polymer solution, then removing and allowing the coating to cure.

Creating and/or forming an oxide layer on the surface of zircaloy tubes can protect against eutectic formation. This may be done by anodizing, sol-gel coating, a portion thereof, combinations thereof, and/or the like. Anodizing may entail an electrochemical process that increases a natural oxide layer on the surface of the zircaloy tubes, enhancing their resistance to corrosion and chemical attack. Sol-Gel Coating may involves dipping the zircaloy SNF tubes in a sol-gel solution, then heat-treating to form a dense, protective oxide layer onto the exteriors of the zircaloy SNF tubes.

Combining different materials to create composite coatings onto the exteriors of the zircaloy SNF tubes may offer enhanced protective properties. This may be done in a layered coatings approach, a nano-composite coatings approach, a portion thereof, combinations thereof, and/or the like. A layered coatings approach may apply alternating layers of different materials, such as, but not limited to, ceramic and metallic materials to take advantage of the properties of both. A nano-composite coatings approach may utilize nanoparticles within a coating matrix to improve the coating's overall performance.

Surface treatments can modify the properties of the exteriors of the zircaloy SNF tubes to prevent or minimize eutectic formation. This may be done by layer cladding, plasma spraying, a portion thereof, combinations thereof, and/or the like. With laser cladding, a laser is used to melt a protective material onto the exterior surface of the zircaloy SNF tubes, creating a metallurgically bonded exterior (outer) protective layer. Plasma spraying, may similar to traditional thermal spraying, but uses a plasma torch to melt and propel the coating material onto the exterior surfaces of the zircaloy SNF tubes, creating a exterior (outer) protective layer.

Chemical Coatings use chemical treatments to form protective layers onto the exterior surfaces of the zircaloy SNF tubes. This may be done by siliconizing, aluminizing, a portion thereof, combinations thereof, and/or the like. Siliconizing may involve a diffusion of silicon into the exterior surfaces of the zircaloy SNF tubes to form a silicon-rich protective layer. Aluminizing may be a process of diffusing aluminum into the exterior surfaces of the zircaloy SNF tubes to form an aluminum-rich protective layer.

Each of these methods may have its own advantages and limitations, and the choice of coating or protection method may depend, at least in part, on specific operational conditions, including temperature, radiation levels, and the chemical environment within the SNF assemblies. In some embodiments, choice and/or selection of one or more anti-eutectic mixtures coating(s) and/or protection method(s), may be handled in the step 809 fissile criticality analysis (FCA).

In some embodiments, method 800 may comprise a step of executing one or more anti-eutectic mixtures coating(s) and/or protection method(s), as noted above. In some embodiments, execution of one or more anti-eutectic mixtures coating(s) and/or protection method(s) may be done prior to execution of step 818. In some embodiments, execution of one or more anti-eutectic mixtures coating(s) and/or protection method(s) may be step 817. In some embodiments, if preheating the SNF assembly may be carried out, execution of one or more anti-eutectic mixtures coating(s) and/or protection method(s) to the SNF assembly may occur before, after, or concurrently with preheating the SNF assembly.

Additionally, selecting copper alloys that do not form eutectic mixtures with zirconium, such as copper-nickel, copper-aluminum, copper-silicon, or copper-beryllium alloys, may mitigate this issue; and one or more of these alloys may be selected as the melt material 409 in some embodiments. These alloys have lower melting points and are less reactive with zirconium, reducing the risk of eutectic reactions.

Furthermore, maintaining strict temperature control during the die cast process (e.g., step 825) may ensure that the operational temperatures remain within safe limits, preventing any unintended reactions.

Through these combined strategies, the integrity of the zircaloy SNF tubes may be preserved, ensuring the safe encapsulation of radioactive materials in the SNF assemblies as taught in this patent application.

Continuing discussing FIG. 8, in some embodiments, step 818 may be a step of inserting (loading) the collected and/or selected SNF assembly (or portion thereof) (e.g., from the step 801) into an open die (mold) 403, prior to the gravity feeding operations commencing within that then closed die (mold) 403. In some embodiments, step 818 may be accomplished with an established robotic handler (e.g., robotic handler 427) and/or the like. In some embodiments, after step 818 has completed, die (mold) 403 may then be closed (with the SNF assembly [or portion thereof] now located within that now closed die [mold] 403). In some embodiments, execution of step 818 may progress method 800 to step 825.

Continuing discussing FIG. 8, in some embodiments, step 823 may be a step of injecting a purge (inert) gas into die (mold) 403 that has a given SNF assembly (or portion thereof) located within that given die (mold) 403 and before the actual gravity feeding of the molten materials 409 into that given die (mold) 403 begins (i.e., before step 825). In some embodiments, gas cylinder(s) 425 and/or gas line 426 may enable and/or support step 823. In some embodiments, the inert gas may be used in the initial stage of the loading process of the die (mold) 403. Inert gases are commonly used in diecasting operations to prevent (or minimize) surface oxidation and/or to improve the casting quality. At least one primary purpose of using inert gases within the die (mold) may be to create a protective atmosphere within the die (mold), during and/or right before the casting process. Typically, an inert gas such as, but not limited to, nitrogen and/or argon is introduced into the diecasting machine's die cavity prior to the gravity feeding of the molten metal(s) and/or alloy(s). In some embodiments, this inert gas may help in several ways, such as, but not limited to: (1) oxidation prevention (mitigation); (2); heat removal (3) porosity reduction; (4) surface finish enhancement; portions thereof; combinations thereof; and/or the like. With respect to oxidation prevention (mitigation), inert gases may create (form) a barrier between the molten metal 409 and the surrounding air, minimizing or preventing oxidation of the metal 409. Oxidation can degrade the quality of the casting 500 and affect its mechanical properties. With respect to heat removal, inert gases aid in the quicker cooling and solidification of the molten metal 409, reducing cycle times and improving productivity. The added inert gas may help in extracting heat from the casting 500, promoting solidification and maintaining dimensional accuracy. With respect to porosity reduction, the use of inert gases can help reduce the formation of gas porosity within the castings 500. By displacing air (and/or other gases) from the die (mold) cavity 403, inert gases minimize the likelihood of gas entrapment in the molten metal 409, resulting in improved structural integrity of the resulting ingots 500. With respect to surface finish enhancement, inert gases may help improve the surface finish of the casting 500 by reducing the formation of oxide films and promoting a cleaner mold surface contact. A specific choice of inert gas and its application may vary depending on particulars of given the die casting process, the type of metal(s) (alloy(s)) being cast, and other well-known factors in the relevant art of metal/alloy diecasting. In some embodiments, the inert gas may be selected from nitrogen, argon, combinations thereof, and/or the like. However, the general objective is to create a controlled environment within the die-casting machine, including the die (mold) 403, to enhance the casting 500 quality and to reduce defects. However, in some embodiments, some or all of the beneficial features of the use of inert gases in the die (mold) 403, may not be necessary in some embodiments of the present invention, since the end product, i.e., ingots 500, may not be consumer nor industrial items of specific required look, feel, and/or quality, but rather items that are destined for deep underground burial encapsulated in a deep horizontal wellbore (and/or human-made cavern). Use of the inert gas into die (mold) 403 may be done before, during, and/or after the gravity feeding process (operation). In some embodiments, execution of step 823 may progress method 800 to after step 818 and/or right before step 825. In some embodiments, step 823 may be optional, skipped, or omitted. Note, if step 823 was omitted or skipped, then step 816 may progress directly to step 825.

Continuing discussing FIG. 8, in some embodiments, step 825 may be a step of gravity feeding (introducing and/or pouring) the melted metal(s) 409 and/or molten alloy(s) 409 into loaded and closed die (mold) 403 that has the SNF assembly (or a portion thereof) located within the closed die (mold) 403. In some embodiments, execution of step 825 may utilize: gravity, local atmospheric pressure, flow port 411, feed port 413, a portion thereof, combinations thereof, and/or the like. In some embodiments, in practice, the gravity feeding process may be at least substantially (mostly) to entirely driven by the gravity head of the molten alloy fluid 409 (e.g., reservoir 407 being vertically located above mold 403). Thus, gravity injection occurs at both high temperature but at essentially zero added pressure (i.e., just local atmospheric pressure), with any pressure above local atmospheric pressure generating entirely from the high temperatures of the molten materials 409. In some embodiments, upon completion of step 825 a given ingot 500 (with a given SNF assembly [or portion thereof] located within that produced ingot 500) may have been generated (outputted). In some embodiments, execution of step 825 may progress method 800 to step 827.

Continuing discussing FIG. 8, in some embodiments, step 813 may be a step of building a given die (mold) 403 and/or or reusing an already built die (mold) 403 (if an already built die (mold) 403 may be suitable for the FCA). In some embodiments, a given die (mold) 403 may be designed, engineered, sized, dimensioned, shaped, and/or the like, so that a given SNF assembly (or portion thereof) fits entirely within that given die (mold) 403 and with an optimal minimum ingot 500 wall thickness 503. Recall, the size, shape, dimensions, exterior surface geometry, weight, and/or the like of a given SNF assembly (or portion thereof) are either preexisting and well-known or may be known prior to building a given die (mold) 403. A given die (mold) 403 is designed and/or engineered so that the given SNF assembly (or portion thereof) fits entirely within that given die (mold) 403. In some embodiments, given die (mold) 403 may be designed, engineered, sized, dimensioned, shaped, and/or the like, from results of the step 809 fissile criticality analysis (FCA). In some embodiments, execution of step 813 may progress method 800 to step 821.

Continuing discussing FIG. 8, in some embodiments, step 821 may be a step of adding, applying, lining, covering, spraying, and/or the like, at least most of the interior (internal) surfaces of die (mold) 403 with at least one release agent 435 that may be configured to aid in the removal (ejection) of ingot 500 after die (mold) 403 of a given gravity injection cycle completes and die (mold) 403 opens. In some embodiments, release agent(s) 435 may reduce friction and/or general stickiness between an exterior of ingot 500 of interior (internal) surfaces of die (mold) 403. Release agents for industrial metal/alloy based diecasting injection molding processes are well known in the industry and such release agents are incorporated by reference. Such release agent(s) and the release processes are both well known in the diecasting industry and allows the molded finished product (casting) to be quickly released from the given mold cavity after injection (and at least some cooling). For example, and without limiting the scope of the present invention, in some embodiments, high temperature capability release agents such as, but not limited to, graphite-based release agents, silicone-based release agents, and/or boron nitride-based release agents may be used for release agent(s) 435. In some embodiments, the release agent(s) 435 may be applied to the interior (internal) surfaces of the die (mold) 403 when die (mold) 403 may be empty (i.e., without a given SNF assembly [or portion thereof]). In some embodiments, the release agent(s) 435 may be applied to the interior (internal) surfaces of the die (mold) 403 when die (mold) 403 may be open or closed, but empty (i.e., without a given SNF assembly [or portion thereof]). In some embodiments, execution of step 821 may progress method 800 to step 819.

Continuing discussing FIG. 8, in some embodiments, step 819 may be a looping and/or iterative step with respect to the gravity fed die cast operations. In some embodiments, step 819 may be a step of continuing the gravity fed die cast operations by sequentially performing desired or necessary, or recommended preparatory steps to collect, treat, and position the SNF assemblies within the die cast molds 403 and resetting the die mold(s) 403 to be ready for new additional gravity diecasting operations. In some embodiments, execution of step 819 may progress method 800 to step 827.

Continuing discussing FIG. 8, in some embodiments, step 827 may be a step of cooling the newly formed ingot 500 sufficiently so that die (mold) 403 may be opened and that newly formed ingot 500 may be removed without that newly formed ingot 500 losing its three-dimensional (3D) shape. Once, ingot 500 has sufficiently cooled, at least an exterior of that ingot 500 will be a solid 3D shape that is self-supporting (with no appreciable liquid flow), i.e., that 3D shape will not change (deform) when ingot 500 is removed from mold 403. In some embodiments, cooling may take only a few minutes to less than an hour. In some embodiments, die (mold) 403 may comprise cooling channels for the movement of a cooling fluid, such as, but not limited to, a liquid and/or a gas. In some embodiments, cooling may be aided by use of a cooling bath (e.g., cooling bath 429). In some embodiments, once ingot 500 has cooled sufficiently (i.e., the at least the exterior of that ingot 500 is a solid 3D shape that is self-supporting), die (mold) 403 may be opened, and that ingot 500 may be ejected (removed). In some embodiments, ingot 500 ejection (removal) from die (mold) 403 may be accomplished with an established robotic handler (e.g., robotic handler 427) and/or with injector pins of die (mold) 403. Note, injector pins of a given diecasting mold are well understood in the industry and are incorporated by reference. In some embodiments, ingot 500 may be removed from die (mold) 403 and into a cooling bath (e.g., cooling bath 429). In some embodiments, step 827 may be a step of cooling ingot 500 and/or of removing (ejecting) ingot 500 from die (mold) 403. In some embodiments, execution of step 827 may progress method 800 to step 829 and/or step 831.

Continuing discussing FIG. 8, in some embodiments, step 829 may be a step of passivating exterior surfaces of ingot 500. In some embodiments, once a given ingot 500 has been ejected (removed) from die (mold) 403, its exterior surfaces may be passivated. In some embodiments, the exterior surfaces of ingot 500 may be passivated by immersing, spraying, painting, coating, a portion thereof, combinations thereof, and/or the like, those exterior surfaces of ingot 500 with predetermined chemicals. Passivation of copper is a process used to create a protective layer on an exterior surface of the copper to improve its corrosion and/or oxidation resistance. The passivation process involves first removing any oxides and/or contaminants from its exterior surface and then secondly, forming a thin, (relatively) chemically inert layer that acts as a barrier against further oxidation and/or corrosion. The passivation of copper is typically achieved through chemical treatments. The specific chemicals and steps used in the passivation process can vary depending on the desired outcome and the application. Some effective protective layers may be organic and/or inorganic. The organic compounds form protective layers on the copper's exterior surface, enhancing its corrosion resistance. Some common organic compounds used for passivating copper may include: benzotriazole (BTA), imidazoles, portions thereof, combinations thereof, and/or the like. Benzotriazole (BTA) is a widely used organic compound for copper passivation. Benzotriazole (BTA) forms a protective layer on the copper's exterior surface, inhibiting corrosion caused by various environmental factors. Imidazoles, such as 1-methylimidazole and 1,2,4-triazole, are organic compounds that can passivate copper exterior surfaces effectively. Imidazoles form stable complexes with copper, preventing further oxidation and corrosion of the copper's exterior surfaces that have treated (coated). In some embodiments, execution of step 829 may progress method 800 to step 831. In some embodiments, execution of step 829 may be optional, skipped, or omitted. Note, if step 829 was omitted or skipped, then step 827 may progress directly to step 831.

Continuing discussing FIG. 8, in some embodiments, step 831 may be a step of loading ingot(s) 500 into waste capsule(s) 600 (see e.g., FIG. 6). In some embodiments, completion of step 831 may result in at least one loaded (filled) and closed (sealed) waste capsule 600 that comprises at least one ingot 500, wherein that at least one ingot 500 comprises at least one entirely (completely) enclosed SNF assembly or portion thereof. In some embodiments, execution of step 831 may progress method 800 to step 835.

Continuing discussing FIG. 8, in some embodiments, step 835 may be a step of inserting (landing) loaded waste capsules 600 (which may be in string 701 format/configuration) into at least one (1) horizontal (lateral) wellbore(s) 703 and/or 901, wherein that at least one (1) horizontal (lateral) wellbore(s) 703 and/or 901 is at least partially located within a deeply located geologic formation 705. See e.g., FIG. 7 and FIG. 9. In some embodiments, drilling rig 907 may be used in executing step 835. In some embodiments, execution of step 835 may progress method 800 to step 837. In some embodiments, execution of step 835 cannot occur until execution of step 833.

Continuing discussing FIG. 8, in some embodiments, step 833 may be a step of building and/or constructing at least one waste disposal system 900 (SuperLAT system 900) that uses deeply located horizontal wellbore(s) 901 that are located at least partially within the given deeply located geologic formation 705. See e.g., FIG. 9. In some embodiments, drilling rig 907 may be used in executing step 833, in building and/or constructing at least one waste disposal system 900 (SuperLAT system 900). In some embodiments it should be noted that execution of step 833 and/or of building the SuperLAT wellbore may occur before, after, or concurrently with any step of method 800, except that the execution of step 833 and/or of building the SuperLAT wellbore must occur before execution of step 835. In some embodiments, execution of step 833 may progress method 800 to step 835.

Continuing discussing FIG. 8, in some embodiments, step 837 may be a step of sealing (closing) a given waste disposal system 900 (SuperLAT system 900). In some embodiments, in executing step 837 at least one plug 915 may be emplaced within a wellbore 703 and/or 903 of the given waste disposal system 900 (SuperLAT system 900). In some embodiments, plug 915 may be made at least mostly (substantially) from concrete, cement, rock, portions thereof, combinations thereof, and/or the like.

FIG. 9 may depict a waste disposal repository system 900 in which waste capsules 600 (with ingots 500) are sequestered in horizontal wellbore(s) 901, wherein the horizontal wellbore(s) 901 are located within deeply located geological formation(s) 705 (wherein a waste disposal repository system 900 that uses such horizontal wellbore(s) 901 that are located within deeply located geological formation(s) 705 may be referred to as a SuperLAT deep disposal system 900). FIG. 9 may depict a partial cutaway view of a system 900 for (long-term) disposing of nuclear, radioactive, hazardous, and/or dangerous waste, such as, but not limited to, ingots 500 (with radioactive waste therein, such as, but not limited to, SNF assemblies 106/506 [or portions thereof]), within the waste capsules 600; wherein such loaded waste capsule(s) 600 may be emplaced within horizontal (lateral) wellbore(s) 901; and wherein at least some section(s) (portion(s) and/or region(s)) of the horizontal (lateral) wellbore(s) 901 may be located within at least one deeply located geologic formation (rock) 705. In some embodiments, each horizontal (lateral) wellbore 901 may be operatively connected to at least one vertical wellbore 903. In some embodiments, lengths of a pair of operatively connected horizontal (lateral) wellbore 901 section and vertical wellbore 903 section may be at least substantially (mostly) orthogonal (perpendicular) to each other (e.g., lateral wellbore 901 segments may be five [5] degrees or less off from being fully ninety degrees orthogonal with its connected vertical wellbore 903). In some embodiments, the vertical wellbore 903 (that is operatively connected to a section of horizontal [lateral] wellbore 901) may run from that section of horizontal (lateral) wellbore 901 (vertically) to a terrestrial (Earth) surface 905. In some embodiments, terrestrial (Earth) surface 905 may be an above ground local terrestrial surface of the Earth, wherein a given vertical wellbore 903 may originate at and descend (vertically) downwards into at least one deeply located geologic formation (rock) 705, which that wellbore may then change directions into the horizontal (lateral) direction to form at least one horizontal (lateral) wellbore 901 located within that at least one deeply located geologic formation (rock) 705. In some embodiments, “vertical” in the context of vertical wellbore 903, may mean that a given vertical wellbore 903 has a length that runs in a direction that is at least substantially (mostly) parallel with a local gravitational vector (local to that given vertical wellbore 903). In some embodiments, at a given well head site, using a given drilling rig 907, from terrestrial (Earth) surface 905, first a given vertical wellbore 903 may be formed and drilled to at least a depth of and into the at least one deeply located geologic formation (rock) 705; and then, using a given drilling rig 907, that wellbore may then change directions into the horizontal (lateral) direction to form at least one horizontal (lateral) wellbore 901 located within that at least one deeply located geologic formation (rock) 705.

Continuing discussing FIG. 9, in some embodiments, drilling rig(s) 907, from terrestrial surface 905, may be used to form wellbore(s) 901, 903, and/or 703. In some embodiments, drilling rig(s) 907 using downhole tools and techniques, from terrestrial surface 905, may be used to land, emplace, load, insert, place, and/or the like waste capsule(s) 600 (with ingots 500 therein) and/or string(s) 701 of waste capsules 600 (with ingots 500 within the waste capsules 600) within wellbore(s) 901, 903, and/or 703. In some embodiments, drilling rig(s) 907 using downhole tools and techniques, from surface 905, may be used to retrieve waste capsule(s) 600 (with ingots 500 within) and/or to retrieve string(s) 701 of waste capsules 600 (with ingots 500 within) from within wellbore(s) 901, 903, and/or 703. In some embodiments, drilling rig 907 may be at least substantially similar to a drilling rig used to form and/or case wellbores in oil and/or gas fields. In some embodiments, forming wellbore(s) 901, 903, and/or 703, as well as, handling waste capsule(s) 600 and/or string(s) 701 of waste capsule(s) 600, within wellbore(s) 901, 903, and/or 703, may be accomplished using drilling rigs, downhole tools, tooling, machines, devices, apparatus, systems, methods, processes, and/or techniques of the oil field industry that are in use today and well understood. Such preexisting downhole drilling rigs, tools, tooling, machines, devices, apparatus, systems, methods, processes, and/or techniques of the oil field industry are incorporated by reference herein as if fully set forth herein.

Continuing discussing FIG. 9, in some embodiments, deeply located geologic formation (rock) 705 may be located at least 5,000 feet (ft) below the terrestrial surface 905, plus or minus 100 feet (ft). In some embodiments, deeply located geologic formation (rock) 705 may be located at least 10,000 feet (ft) below the terrestrial surface 905, plus or minus 100 feet (ft). In some embodiments, deeply located geologic formation (rock) 705 may have a vertical thickness between fifty (50) feet (plus or minus ten feet) and 3,000 feet (plus or minus fifty feet). In some embodiments, deeply located geologic formation(s) (rock(s)) 705 may be of geological formations selected from: tight shales, deeply bedded salt formations, deep bed-rock granite formations, a portion thereof, combinations thereof, and/or the like. These types of geological formations usually (typically and/or often) all have very limited permeability and very low intrinsic water saturations, which contribute to be suitable geologic formations for deeply located geologic formation(s) (rock(s)) 705 that may accommodate long-term storage (disposal) of dangerous wastes therein with risking harm to the exterior ecosphere.

Continuing discussing FIG. 9, in some embodiments, located local to, adjacent to, and/or proximate to a given vertical wellbore 903 wellhead, on terrestrial (Earth) surface 905, may be at least one nuclear power generation reactor plant 911. In some embodiments, located onsite to a given vertical wellbore 903 wellhead, on terrestrial (Earth) surface 905, may be at least one nuclear power generation reactor plant 911. In some embodiments, operation of nuclear power generation reactor plant 911 may yield electrical power, typically for grid distribution and may also yield SNF that requires safe, efficient, and cost-effective long-term disposal, such as, but not limited to, disposal within a given waste repository system 900. In some embodiments, located, local to, adjacent to, and/or proximate to a given vertical wellbore 903 wellhead, on terrestrial (Earth) surface 905, may be at least one infrastructure building or structure 913. In some embodiments, located onsite to a given vertical wellbore 903 wellhead, on terrestrial (Earth) surface 905, may be at least one infrastructure building or structure 913. In some embodiments, infrastructure building or structure 913 may comprise one or more of: SNF cooling pools, SNF cooling ponds, SNF temporary storage casks, control rooms, operations rooms, warehouses, maintenance and engineering workshops, offices, and/or other building(s) and/or structures typical to have at a nuclear power generation reactor plant 911 site. In this context of surface 905 structure(s), objects, and/or building(s) 913 of a particular nuclear power generation reactor plant 911 site, SNF cooling pond(s)/pool(s) site, SNF temporary storage site, and/or system 900 site, “local,” “onsite,” “adjacent,” and/or “proximate” may be five (5) miles or less. Note, “site” may be as that term is used and/or defined in U.S. non-provisional utility patent application, patent application Ser. No. 18/108,001, filed Feb. 9, 2023, by the same inventor as the present patent application (Henry Crichlow).

Continuing discussing FIG. 9, in some embodiments, after a given horizontal (lateral) wellbore 901 has been at least partially to fully filled with waste capsules 600 (containing ingots 500), that given repository system 900 may be sealed (closed off) by placing at least one plug 915 within a section of vertical wellbore 903, that operatively connects to that at least partially filled horizontal (lateral) wellbore. In some embodiments, plug 915 may be at least partially made from concrete, steel, and/or rock 705 material. In some embodiments, an emplaced plug 915, within a given wellbore 903, may close off that wellbore system, from liquid (water) and/or mechanical/particulate intrusion and/or migration issues.

In some embodiments, a given nuclear, radioactive, hazardous, and/or dangerous waste repository system 900 (SuperLAT system 900) may comprise at least one of (one or more of): at least one horizontal (lateral) wellbore 901 located (entirely) within at least one deeply located geologic formation (rock) 705, at least one vertical wellbore 903 that may operatively connect to that at least one horizontal (lateral) wellbore 901 and that may run from that at least one horizontal (lateral) wellbore 901 to terrestrial surface 905; at least one waste capsule 600 (with at least one ingot 500 located within that at least one waste capsule 600); at least one emplaced plug 915 located within that at least one vertical wellbore 903; at least one drilling rig 907; at least one nuclear power generation reactor plant 911 (operational, non-operational, and/or decommissioned); at least one infrastructure building or structure 913; combinations thereof; and/or the like.

While FIG. 9 shows one overall site, it should be noted that various embodiments of the present invention may interact with and/or utilize two or more of such sites as shown in FIG. 9. Further, in some embodiments, those two or more sites, some such sites may have the nuclear power generation plant 911 and/or the structure(s) 913 but without the disposal wellbore system; or some such sites may have the disposal wellbore system but without the nuclear power generation plant 911 and/or without the structure(s) 913; or such sites may be as substantially (mostly) shown in FIG. 9.

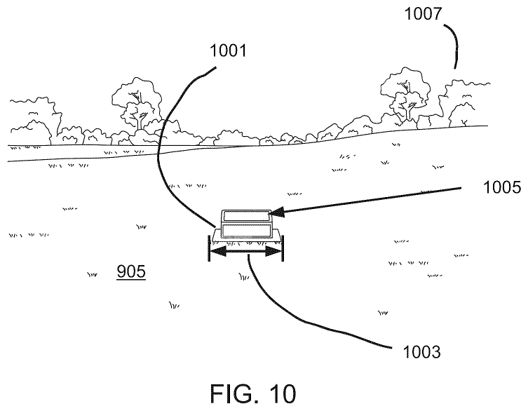

FIG. 10 illustrates an example of a type of relatively small surface plaque 1001, generally made of concrete (or other masonry product or long lasting, durable, and generally difficult to move by hand product), having nominal dimensions 1003 of about two (2) feet (ft) square, +/−one-half (½) ft, with a brass (or other durable and/or long lasting material) inscription plate 1005, that may provide terrestrial surface 905 indication that a deep nuclear waste repository 700 is built and located 10,000 feet underground, or more, using a SuperLAT™ horizontal wellbore system.

In some embodiments, the surface plaque 1001 and/or the inscription plate 1005 may include at least one (passive) RFID tag, QR code, barcode, and/or the like, that upon proper interrogation (reading) may yield information about that site.

In the late 1960s a series of commercial atomic tests were conducted in the Rocky Mountains region of the United States (U.S.), specifically under Project Plowshare, which explored peaceful uses of nuclear explosives. Each test involved detonating nuclear devices at specific depths to fracture rock and release trapped gas. Detonation depths ranged from 4,240 feet deep to 8,426 feet deep below terrestrial surface 905. The atomic yields ranged from 29 kilotons to 99 kilotons. Today, in 2024 these sites include historical markers that provide information about those operations that are substantially similar to the concrete and brass embodiment of FIG. 10. Those markers serve both as an educational resource and as a reminder of the experiment conducted there below. The remediation efforts for the atomic sites focused on ensuring that any potential contamination from the underground nuclear explosion was contained and that the surface 905 environment was restored to a safe condition. Today, the sites are marked and monitored, but have all largely returned to their natural state within the Rocky Mountain region. There are no significant restrictions on access, and the site is considered safe for visitors, without restriction, with informational signage indicating its historical significance.

A similar type of plaque or marker 1001 located among trees 1007 and its field, is shown in FIG. 10 where up to 1,000,000 pounds (lbs) of HLW may be buried in nuclear waste capsules 600 in SuperLAT™ horizontal wellbores 901.

Note, various embodiments of the present invention may be characterized as methods, devices, apparatus, systems, portions thereof, and/or the like.

For example, and without limiting the scope of the present invention, device and/or apparatus embodiments of the present invention may comprise ingot 500 (casting 500). In some embodiments, ingot 500 may comprise at least one spent nuclear fuel assembly or portion thereof and molten composition 409 that has resolidified, wherein the molten composition 409 that has resolidified both entirely and completely covers over an exterior of the at least one spent nuclear fuel assembly or portion thereof and also penetrates into the internal void spaces 301 of the at least one spent nuclear fuel assembly or portion thereof. In some embodiments, ingot 500 may be manufactured from a gravity fed diecasting molding process. In some embodiments, the molten composition 409 may comprise at least one alloy of copper and optionally, at least one neutron absorber, such as, but not limited to, boron carbide (B₄C). See e.g., FIG. 8, method 800, and FIG. 4 to FIG. 5C.

For example, and without limiting the scope of the present invention, system embodiments of the present invention may comprise a system for processing spent nuclear fuel assemblies or portions thereof, wherein the system may comprise at least one ingot 500 (casting 500). In some embodiments, the at least one ingot 500 may comprise at least one spent nuclear fuel assembly or portion thereof, selected from the spent nuclear fuel assemblies or portions thereof, and wherein the at least one ingot 500 may further comprise molten composition 409 that has resolidified, wherein the molten composition 409 that has resolidified both entirely and completely covers over an exterior of the at least one spent nuclear fuel assembly or portion thereof and also penetrates into the internal void spaces 301 of the at least one spent nuclear fuel assembly or portion thereof. In some embodiments, this system may further comprise at least one of: at least one diecast mold 403; at least one waste capsule 600; at least one string 701 of two or more waste capsules 600; at least one horizontal wellbore 703 and/or 901 that is located at least partially within a deeply located geologic formation 705; gravity fed components 405; melt furnace 407 and/or melt reservoir 407; heater 410; molten composition 409; flow port 411; feed port 413; neutron absorber 417; neutron absorber reservoir 421; port 423 for neutron absorber; neutron absorber; gas cylinder 425; gas line 426; robotic handler 427; cooling bath 429; controller 431; release agent 435; outlet port 437; outlet reservoir 439; support 441; ejection means; plate 603; sleeve 609; support (standoff) 611; pipe 605; pipe coupling 607; vertical wellbore 903; drilling rig 907; plug 915; a portion thereof; combinations thereof; and/or the like. In some embodiments, the at least one diecast mold 403 may have been used in forming the at least one ingot 500 from a diecast gravity injection molding process (e.g., method 800), wherein the at least one diecast mold 403 may be configured to house the at least one spent nuclear fuel assembly or portion thereof. In some embodiments, the at least one waste capsule 600 may be configured to house the at least one ingot 500. In some embodiments, the at least one horizontal wellbore 901 (703) may be configured to hold the at least one ingot 500 (and/or at least one waste capsule 600) therein, wherein the at least one horizontal wellbore 901 (703) may operationally connect to at least one vertical wellbore 903 that runs to a terrestrial surface 905.

For example, and without limiting the scope of the present invention, method embodiments of the present invention may comprise method 800 for processing spent nuclear fuel assemblies or portions thereof for long-term disposal. In some embodiments, the at least one spent nuclear fuel assembly or portion thereof that is referred to in method 800 and/or in this patent application may be a spent nuclear fuel assembly or portion thereof that was manufactured in: the United States of America (U.S.), Canada, Russia, Sweden, Finland, or other country. In some embodiments, method 800 may comprise a step (a), a step (b), and a step (c).

In some embodiments, the step (a) may be the same or at least substantially (mostly) the same as step 818. In some embodiments, the step (a) may comprise placing at least one spent nuclear fuel (SNF) assembly or portion thereof, selected from the spent nuclear fuel assemblies or portions thereof (e.g., step 801), into a diecast mold 403 and closing the diecast mold 403 around the at least one spent nuclear fuel assembly or portion thereof. In some embodiments, the diecast mold 403 may be configured to entirely and completely enclose the at least one spent nuclear fuel assembly or portion thereof when the diecast mold 403 may be closed. See e.g., FIG. 4 and FIG. 8.

In some embodiments, the step (b) may be the same or at least substantially (mostly) the same as step 825. In some embodiments, the step (b) may comprise gravity feeding (introducing and/or pouring) into the diecast mold 403, that is closed and that houses the at least one spent nuclear fuel assembly or portion thereof, a molten composition 409, that upon sufficient cooling after the gravity feeding has finished forms an ingot 500 (a casting 500). In some embodiments, the sufficient cooling may be when a temperature of at an exterior of the molten composition 409 within the diecast mold 403 has lowered enough after the step (b) gravity feeding has stopped for the exterior of the molten composition 409 to have resolidified (and/or for ingot 500 to be self-supporting with respect to its shape not changing). In some embodiments, ingot 500 may comprise the molten composition 409 that was gravity feed into the diecast mold 403 and that has resolidified and wherein the ingot 500 may further comprise the at least one spent nuclear fuel assembly or portion thereof (that may be located entirely within that ingot 500).

In some embodiments, the step (c) may be the same or at least substantially (mostly) the same as step 827. In some embodiments, the step (c) may comprise ejecting (removing) the ingot 500 from the diecast mold 403 by opening the diecast mold 403 and using an ejection means to eject (remove) the ingot 500. In some embodiments, the ejection means may comprise at least one robotic handler (e.g., robotic handler 427) and/or ejector pins 428 of diecast mold 403, that may be configured to remove the ingot 500 from the diecast mold 403 that is open.

In some embodiments, the step (b) gravity feeding step may be accomplished by gravity feeding components 405. In some embodiments, the step (b) gravity feeding step may be accomplished by physically and operationally linking reservoir 407 to the diecast mold 403 (e.g., via piping, conduits, ports, spruces, a portion thereof, combinations thereof, and/or the like). In some embodiments, reservoir 407 is configured to hold at least some of the molten composition 409. In some embodiments, reservoir 407 is located vertically above the diecast mold 403 and is configured to facilitate the at least some of the molten composition 409 flowing from reservoir 407 and into the diecast mold 403 by gravity. In some embodiments, the reservoir 407 may be heated (e.g., by heater 410) to generate and/or maintain the at least some of the molten composition 409 in a molten (melted and/or liquid) configuration (state). See e.g., FIG. 4 and FIG. 8.

In some embodiments, during the step (b) gravity feeding step, the molten composition 409 that is injected into the diecast mold 403 both entirely covers over exteriors of the at least one spent nuclear fuel assembly or portion thereof that is located within the diecast mold 403 and also penetrates into internal void spaces 301 of the at least one spent nuclear fuel assembly or portion thereof.

In some embodiments, the molten composition 409 may comprise at least one alloy of copper. In some embodiments, the molten composition 409 may further comprise at least one neutron absorber. In some embodiments, the at least one neutron absorber is configured to absorb neutron emissions from the at least one spent nuclear fuel assembly or portion thereof. In some embodiments, the at least one neutron absorber may be boron carbide (B₄C).

In some embodiments, with respect to a given ingot 500, the at least one spent nuclear fuel assembly or portion thereof may be entirely and completely disposed within an exterior of that ingot 500 after the step (b) gravity feeding has stopped (or finished) such that between the exterior of the ingot 500 and an exterior of the at least one spent nuclear fuel assembly or portion thereof is a minimum thickness 503 of the molten composition 409 that has resolidified. See e.g., FIG. 5B and FIG. 5A.

In some embodiments, the method 800 (after executing the step (c) [e.g., step 827]) may (optionally) further comprise a step of passivating an exterior of the ingot 500 (see e.g., step 829); wherein, in some embodiments, this passivating step may occur after the step (c).

In some embodiments, the method 800 (after executing the step (c)) may further comprise a step of placing at least one ingot 500 into at least one waste capsule 600 (see e.g., FIG. 6 and FIG. 8, step 831). In some embodiments, the at least one waste capsule 600 may comprise neutron absorbing members that are configured to surround the at least one ingot 500 within the waste capsule 600. In some embodiments, the neutron absorbing members may be configured to absorb neutron emissions from the at least one ingot 500. In some embodiments, the neutron absorbing members may comprise a sleeve 609 and/or plates 603. In some embodiments, the sleeve 609 may be hollow (cylindrical) and may be configured to fit over an exterior length of the at least one ingot 500. In some embodiments, the plates 603 may be configured to be placed at opposing terminal ends of the at least one ingot 500. In some embodiments, the sleeve 609 and/or the plates 603, may be at least partially made from borated steel. See e.g., FIG. 6.

In some embodiments, the method 800 (after executing the step (c)) may further comprise a step of inserting the at least one waste capsule 600 into a horizontal wellbore 901 that is located at least partially within a deeply located geologic formation 705 (see e.g., step 833). In some embodiments, the horizontal wellbore 901 may (operationally) connect to a vertical wellbore 903 that runs to a terrestrial surface 705. See e.g., FIG. 7, FIG. 8, and FIG. 9.

In some embodiments, prior to the step (a), the method 800 may comprise a step of coating interior surfaces of the diecast mold 403 with at least one release agent 435 (see e.g., step 821). In some embodiments, the at least one release agent 435 may be configured to promote the step (c) ejection (removal) of the ingot 500 from the diecast mold 403. In some embodiments, the at least one release agent 435 may be at least one component/aspect of the ejection means. See e.g., FIG. 4 and FIG. 8.

In some embodiments, after the step (a) but prior to the step (b), the method 800 may further comprise a step of purging an internal volume 433 of inside of the diecast mold 403 that is closed with at least one purge gas (see e.g., step 823). In some embodiments, this purge process may be done to remove at least substantially (most) of oxygen (e.g., from atmospheric air) from the internal volume 433 of inside of the diecast mold 403 that is closed, to minimize oxidation of exterior surfaces of ingot 500. In some embodiments, the at least one purge gas may be a gas that is generally considered to be substantially (mostly) inert, such as, but not limited to, nitrogen, argon, a portion thereof, combinations thereof, and/or the like.

In some embodiments, die (mold) 403 may be configured to entirely house (hold) any SNF assembly or portion thereof noted and/or discussed herein, such as, but not limited to, SNF assembly 106, group (bundle) of SNF assemblies 105, SNF assembly 101, SNF assembly 103, modified SNF assembly 506, SNF assembly 205, base 307, spent nuclear fuel assembly, fuel rod, fuel pellet, control rod, portions thereof, combinations thereof, and/or the like.

Methods of forming metal alloy ingots that contain high-level nuclear waste (HLW), such as, but not limited to, spent nuclear fuel (SNF) assemblies, or portions thereof, from diecast gravity injection molding operations, these ingots, methods of disposing of these ingots into deeply located wellbores, and systems thereof have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A method for processing spent nuclear fuel assemblies or portions thereof for long-term disposal, wherein the method comprises steps of:
(a) placing at least one spent nuclear fuel assembly or portion thereof, selected from the spent nuclear fuel assemblies or portions thereof, into a diecast mold and closing the diecast mold around the at least one spent nuclear fuel assembly or portion thereof;
(b) gravity feeding into the diecast mold that is closed and that houses the at least one spent nuclear fuel assembly or portion thereof, a molten composition that upon sufficient cooling after the gravity feeding has finished forms an ingot, wherein the ingot comprises the molten composition that was gravity fed into the diecast mold and that has solidified, and wherein the ingot further comprises the at least one spent nuclear fuel assembly or portion thereof; and
(c) ejecting the ingot from the diecast mold by opening the diecast mold and using an ejection means to eject the ingot.

2. The method according to claim 1, wherein the at least one spent nuclear fuel assembly or portion thereof is a spent nuclear fuel assembly or portion thereof that was manufactured in: United States of America, Canada, Russia, Sweden, or Finland.

3. The method according to claim 1, wherein the diecast mold is configured to entirely and completely enclose the at least one spent nuclear fuel assembly or portion thereof when the diecast mold is closed.

4. The method according to claim 1, wherein the step (b) gravity feeding is accomplished by physically and operationally linking a reservoir to the diecast mold, wherein the reservoir is configured to hold at least some of the molten composition; wherein the reservoir is located vertically above the diecast mold and is configured to facilitate the at least some of the molten composition flowing from the reservoir and into the diecast mold by gravity.

5. The method according to claim 4, wherein the reservoir is heated to generate and/or maintain the at least some of the molten composition in a molten configuration.

6. The method according to claim 1, wherein during the step (b) gravity feeding, the molten composition that is gravity fed into the diecast mold both entirely covers exteriors of the at least one spent nuclear fuel assembly or portion thereof that is located within the diecast mold and also penetrates into internal void spaces of the at least one spent nuclear fuel assembly or portion thereof.

7. The method according to claim 1, wherein the sufficient cooling is when a temperature of an exterior of the molten composition within the diecast mold has lowered enough after the step (b) gravity feeding has stopped for the exterior of the molten composition to have resolidified.

8. The method according to claim 1, wherein the molten composition comprises at least one alloy of copper.

9. The method according to claim 8, wherein the molten composition further comprises at least one neutron absorber, wherein the at least one neutron absorber is configured to absorb neutron emissions from the at least one spent nuclear fuel assembly or portion thereof.

10. The method according to claim 9, wherein the at least one neutron absorber is boron carbide (B₄C).

11. The method according to claim 1, wherein the step (b) gravity feeding further comprises injecting at least one neutron absorber into the diecast mold, wherein the at least one neutron absorber is configured to absorb neutron emissions from the at least one spent nuclear fuel assembly or portion thereof.

12. The method according to claim 1, wherein with respect to the ingot, the at least one spent nuclear fuel assembly or portion thereof is entirely and completely disposed within an exterior of the ingot after the step (b) gravity feeding is stopped such that between the exterior of the ingot and an exterior of the at least one spent nuclear fuel assembly or portion thereof is a minimum thickness of the molten composition that has resolidified.

13. The method according to claim 1, wherein the ejection means comprises at least one robotic handler that is configured to remove the ingot from the diecast mold that is open.

14. The method according to claim 1, wherein the method further comprises a step of passivating an exterior of the ingot.

15. The method according to claim 1, wherein the method further comprises a step of placing at least one ingot into at least one waste capsule.

16. The method according to claim 15, wherein the at least one waste capsule comprises neutron absorbing members that are configured to surround the at least one ingot within the waste capsule, wherein the neutron absorbing members are configured to absorb neutron emissions from the at least one ingot.

17. The method according to claim 16, wherein the neutron absorbing members comprise a sleeve and plates, wherein the sleeve is hollow and is configured to fit over an exterior length of the at least one ingot, and wherein the plates are configured to be placed at opposing terminal ends of the at least one ingot.

18. The method according to claim 17, wherein the sleeve and/or the plates, are at least partially made from borated steel.

19. The method according to claim 15, wherein the method further comprises a step of inserting the at least one waste capsule into a horizontal wellbore that is located at least partially within a deeply located geologic formation, wherein the horizontal wellbore connects to a vertical wellbore that runs to a terrestrial surface.

20. The method according to claim 1, wherein prior to the step (a), the method comprises a step of coating interior surfaces of the diecast mold with at least one release agent, wherein the at least one release agent is configured to promote the step (c) ejection of the ingot from the diecast mold.

21. The method according to claim 1, wherein after the step (a) but prior to the step (b), the method further comprises a step of purging an internal volume of inside of the diecast mold that is closed with at least one purge gas.

22. A system for processing spent nuclear fuel assemblies or portions thereof, wherein the system comprises at least one ingot, wherein the at least one ingot comprises at least one spent nuclear fuel assembly or portion thereof, selected from the spent nuclear fuel assemblies or portions thereof, and wherein the at least one ingot further comprises a molten composition that has resolidified, wherein the molten composition that has resolidified both entirely and completely covers an exterior of the at least one spent nuclear fuel assembly or portion thereof and also penetrates into internal void spaces of the at least one spent nuclear fuel assembly or portion thereof.

23. The system according to claim 22, wherein the system further comprises at least one diecast mold, wherein the at least one diecast mold was used in forming the at least one ingot from a gravity fed diecast molding process, wherein the at least one diecast mold is configured to house the at least one spent nuclear fuel assembly or portion thereof.

24. The system according to claim 22, wherein the system further comprises at least one waste capsule, wherein the at least one waste capsule is configured to house the at least one ingot.

25. The system according to claim 22, wherein the system further comprises at least one horizontal wellbore that is located at least partially within a deeply located geologic formation, wherein the at least one horizontal wellbore is configured to hold the at least one ingot therein, wherein the at least one horizontal wellbore connects to at least one vertical wellbore that runs to a terrestrial surface.

26. A diecast casting that comprises at least one spent nuclear fuel assembly or portion thereof and a molten composition that has resolidified, wherein the molten composition that has resolidified both entirely and completely covers an exterior of the at least one spent nuclear fuel assembly or portion thereof and also penetrates into internal void spaces of the at least one spent nuclear fuel assembly or portion thereof.

27. The ingot according to claim 26, wherein the diecast casting is manufactured from a gravity fed diecasting molding process.

28. The ingot according to claim 26, wherein the molten composition comprises at least one alloy of copper.
